(19) United States
(12) Patent Application Publication
(10) Pub. No.: US 2024/0375413 A1
(43) Pub. Date: Nov. 14, 2024

(54) LIQUID EJECTION APPARATUS AND METHOD OF CONTROLLING LIQUID EJECTION APPARATUS

(71) Applicant: SEIKO EPSON CORPORATION, Tokyo (JP)

(72) Inventors: Hiroshi SHIOBARA, MATSUMOTO-SHI (JP); Takeru OGUCHI, CHINO-SHI (JP); Tatsuya HOSOKAWA, MATSUMOTO-SHI (JP); Chiaki SHIMADA, OKAYA-SHI (JP)

(21) Appl. No.: 18/655,926

(22) Filed: May 6, 2024

(30) Foreign Application Priority Data
May 9, 2023 (JP) 2023-077088

(51) Int. Cl. B41J 11/00; B41J 13/00; B41J 13/08; B41J 29/46

(52) U.S. Cl. CPC B41J 11/006; B41J 11/0095; B41J 13/0027; B41J 13/08; B41J 29/46

(57) ABSTRACT

A printer includes a line head that ejects ink onto a sheet, a belt conveyance unit that supports the sheet, an upstream conveyance roller pair that conveys the sheet to the belt conveyance unit, a downstream conveyance roller pair that conveys the sheet from the belt conveyance unit, and a controller, wherein the belt conveyance unit can be displaced between a first position opposed to the line head and a second position at a longer distance from the line head than the first position by rotating, and the controller displaces the belt conveyance unit to the second position, and controls the belt conveyance unit, the upstream conveyance roller pair, and the downstream conveyance roller pair such that the sheet forms a curve convex downward in a vertical direction when the conveyance stops.

The present application is based on, and claims priority from JP Application Serial Number 2023-077088, filed May 9, 2023, the disclosure of which is hereby incorporated by reference herein in its entirety.

### BACKGROUND

### 1. Technical Field

The present disclosure relates to a liquid ejection apparatus for ejecting liquid onto a medium and a method of controlling the liquid ejection apparatus.

### 2. Related Art

JP-A-2021-115791 discloses an image forming apparatus in which a medium is conveyed from an upstream conveyance unit to an intermediate conveyance unit, printing is performed by a print unit on the intermediate conveyance unit, and the medium after printing is conveyed from the intermediate conveyance unit to a downstream conveyance unit. In the image forming apparatus, when the conveyance of the medium is stopped due to a sheet jam or the like in a state where both of the upstream conveyance unit and the downstream conveyance unit hold the medium, for example, the downstream conveyance unit is made to forward the medium toward the intermediate conveyance unit, and at the same time, the intermediate conveyance unit is separated from the print unit. As a result, since a distance between the print unit and the intermediate conveyance unit increases, and at the same time, the downstream end portion of the medium comes into a state of hanging down onto the intermediate conveyance unit, the medium can be prevented from making contact with the print unit when the medium is removed.

JP-A-2021-115791 is an example of the related art.

However, in the liquid ejection apparatus that forms an image by ejecting liquid from the print unit to the medium, when one end of the medium in the middle of printing hangs down, the liquid just ejected flows down from the medium and may stain the inside of the apparatus.

### SUMMARY

A liquid ejection apparatus includes a recording unit configured to perform recording by ejecting liquid onto a medium, a conveyance unit configured to convey the medium, and a controller configured to control the conveyance unit, wherein the conveyance unit includes a support unit opposed to the recording unit and configured to support the medium on which the liquid is ejected, an upstream conveyance unit located upstream in a conveyance direction of the support unit of the medium, and configured to convey the medium to the support unit, and a downstream conveyance unit located downstream in the conveyance direction of the support unit, and configured to convey the medium from the support unit, the support unit is selectively displaced between a first position opposed to the recording unit and a second position at a longer distance from the recording unit than the first position by rotating taking an axis along a width direction crossing the conveyance direction as a rotational axis, and the controller controls the support unit to be displaced to the second position, and controls the conveyance unit such that the medium forms a curve convex downward in a vertical direction when the conveyance stops in a state where at least a part of the medium is supported by the support unit.

A method of controlling a liquid ejection apparatus is a method of controlling a liquid ejection apparatus including a recording unit configured to perform recording by ejecting liquid onto a medium, a support unit opposed to the recording unit, and configured to support the medium on which the liquid is ejected, an upstream conveyance unit located upstream in a conveyance direction of the support unit of the medium, and configured to convey the medium to the support unit, a downstream conveyance unit located downstream in the conveyance direction of the support unit, and configured to convey the medium from the support unit, and a detection unit configured to detect the medium at a position downstream in the conveyance direction of the downstream conveyance unit, the method including conveying the medium in the conveyance direction until the detection unit successfully detects the medium when the detection unit fails to detect the medium when the conveyance stops in a state where at least a part of the medium is supported by the support unit, conveying the medium in an opposite direction to the conveyance direction within a range for the detection unit to detect the medium when the detection unit detects the medium when the conveyance stops in the state where at least a part of the medium is supported by the support unit, separating the support unit from the recording unit by rotating the support unit centering on a rotational axis located upstream in the conveyance direction of a center in the conveyance direction of the support unit, and controlling the upstream conveyance unit and the support unit such that the medium is supported by the downstream conveyance unit and the support unit to thereby form a curve convex downward in a vertical direction.

A method of controlling a liquid ejection apparatus is a method of controlling a liquid ejection apparatus including a recording unit configured to perform recording by ejecting liquid onto a medium, a support unit opposed to the recording unit, and configured to support the medium on which the liquid is ejected, an upstream conveyance unit located upstream in a conveyance direction of the support unit of the medium, and configured to convey the medium to the support unit, a downstream conveyance unit located downstream in the conveyance direction of the support unit, and configured to convey the medium from the support unit, and a detection unit configured to detect the medium at a position upstream in the conveyance direction of the upstream conveyance unit, the method including conveying the medium in an opposite direction to the conveyance direction until the detection unit successfully detects the medium when the detection unit fails to detect the medium when the conveyance stops in a state where at least a part of the medium is supported by the support unit, conveying the medium in the conveyance direction within a range for the detection unit to detect the medium when the detection unit detects the medium when the conveyance stops in the state where at least a part of the medium is supported by the support unit, separating the support unit from the recording unit by rotating the support unit centering on a rotational axis located downstream in the conveyance direction of a center in the conveyance direction of the support unit, and controlling the support unit and the downstream conveyance unit such that the medium is supported by the upstream conveyance unit and the support unit to thereby form a curve convex downward in a vertical direction.

### BRIEF DESCRIPTION OF THE DRAWINGS

FIG. 1 is a perspective view showing an external appearance of a printer.

FIG. 2 is a schematic view showing a conveyance path of a sheet in the printer.

FIG. 3 is a side view showing a schematic configuration of a belt conveyance unit.

FIG. 4 is a diagram illustrating a posture of the belt conveyance unit, and is a diagram showing a first posture.

FIG. 5 is a diagram illustrating a posture of the belt conveyance unit, and is a diagram showing a second posture.

FIG. 6 is a diagram illustrating a posture of the belt conveyance unit, and is a diagram showing a third posture.

FIG. 7 is a perspective view showing the belt conveyance unit in the first posture and a posture switching unit.

FIG. 8 is block a diagram showing a configuration of a control system of the printer.

FIG. 9 is a flowchart showing an operation of the printer when a conveyance abnormality occurs.

FIG. 10 is a side view showing a state of the belt conveyance unit and the sheet.

FIG. 11 is a side view showing a state of the belt conveyance unit and the sheet.

FIG. 12 is a side view showing a state of the belt conveyance unit and the sheet.

FIG. 13 is a side view showing the state of the belt conveyance unit and the sheet.

FIG. 14 is a side view showing the state of the belt conveyance unit and the sheet.

FIG. 15 is a side view showing the state of the belt conveyance unit and the sheet.

FIG. 16 is a side view showing the state of the belt conveyance unit and the sheet.

FIG. 17 is a side view illustrating the state of the belt conveyance unit and the sheet.

FIG. 18 is a side view showing a schematic configuration of a belt conveyance unit according to a second embodiment.

FIG. 19 is a flowchart showing an operation of a printer when a conveyance abnormality occurs in the second embodiment.

FIG. 20 is a side view showing a state of the belt conveyance unit and a sheet.

FIG. 21 is a side view showing the state of the belt conveyance unit and the sheet.

FIG. 22 is a side view showing the state of the belt conveyance unit and the sheet.

FIG. 23 is a side view showing the state of the belt conveyance unit and the sheet.

FIG. 24 is a side view showing the state of the belt conveyance unit and the sheet.

FIG. 25 is a side view showing the state of the belt conveyance unit and the sheet.

FIG. 26 is a side view showing the state of the belt conveyance unit and the sheet.

FIG. 27 is a side view showing the state of the belt conveyance unit and the sheet.

### DESCRIPTION OF EMBODIMENTS

### 1. First Embodiment

Hereinafter, a printer 1 of a first embodiment will be described with reference to the drawings.

The printer 1 is an inkjet printer that records an image on a medium by ejecting liquid onto a medium to be conveyed. The printer 1 is an example of a liquid ejection apparatus.

In each drawing, an X axis, a Y axis, and a Z axis intersecting each other are shown. Typically, the X axis, the Y axis, and the Z axis are orthogonal to each other. The +X directions parallel to the X axis are parallel to an installation surface of the printer 1 and correspond to front-rear directions of the printer 1. The +X directions also correspond to a width direction of a medium in a conveyance path in the printer 1. +Y directions parallel to the Y axis are parallel to the installation surface of the printer 1 and correspond to a left-right direction of the printer 1. +Z directions parallel to the Z axis are perpendicular to the installation surface of the printer 1 and correspond to a vertical direction of the printer 1. In each drawing, the +X direction is a direction from a front surface to a back surface of the printer 1, the +Y direction is a left direction when facing to the front surface of the printer 1, and the +Z direction is an upward direction, namely, an upper side in a vertical direction.

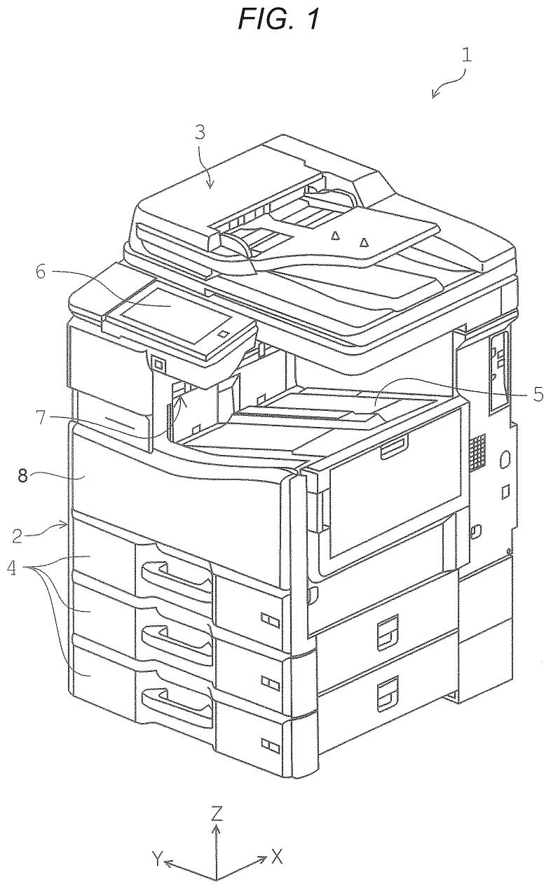

FIG. 1 is a perspective view showing an external appearance of the printer 1.

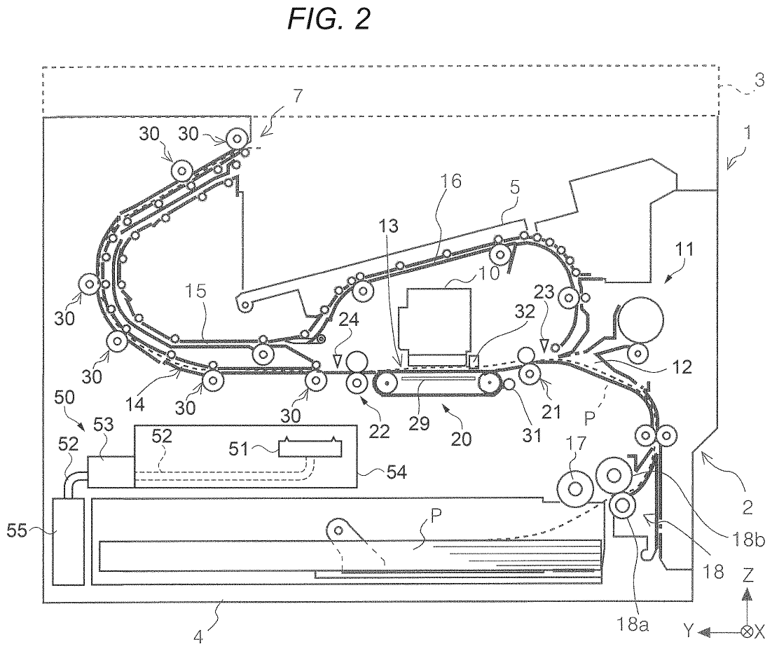

As shown in FIG. 1, the printer 1 is a multi-function device including an apparatus body 2 and a scanner unit 3. The scanner unit 3 is disposed above the apparatus body 2. The apparatus body 2 includes a plurality of sheet storage cassettes 4 that accommodate a sheet P (see FIG. 2) as a medium. The sheet storage cassettes 4 are disposed in a lower part of the apparatus body 2, and are detachably attached from a front surface side of the apparatus body 2. The sheet P is a sheet such as plain paper, thick paper, or photo paper.

Above the sheet storage cassettes 4 in the apparatus body 2, a discharge unit 7 for discharging the sheet P on which recording is performed, and a medium placement portion 5 on which the sheet P discharged from the discharge unit 7 is placed are provided. Further, an operation panel 6 is disposed on the front side of the apparatus body 2. The operation panel 6 includes a display unit such as a liquid crystal panel and an input unit for inputting various instructions to the printer 1.

On a front surface of the apparatus body 2, a front cover 8 that can be opened and closed is disposed above the sheet storage cassettes 4. When a conveyance abnormality such as a sheet jam occurs, for example, the front cover 8 is opened when removing the sheet P which became unusable.

FIG. 2 is a schematic view showing a conveyance path 11 for the sheet P in the printer 1.

The printer 1 according to the present embodiment includes a line head 10 and the conveyance path 11. The line head 10 records an image based on print data input from an external device or the like on the sheet P by ejecting ink, which is an example of liquid, onto the sheet P based on the print data. The line head 10 is an example of a recording unit.

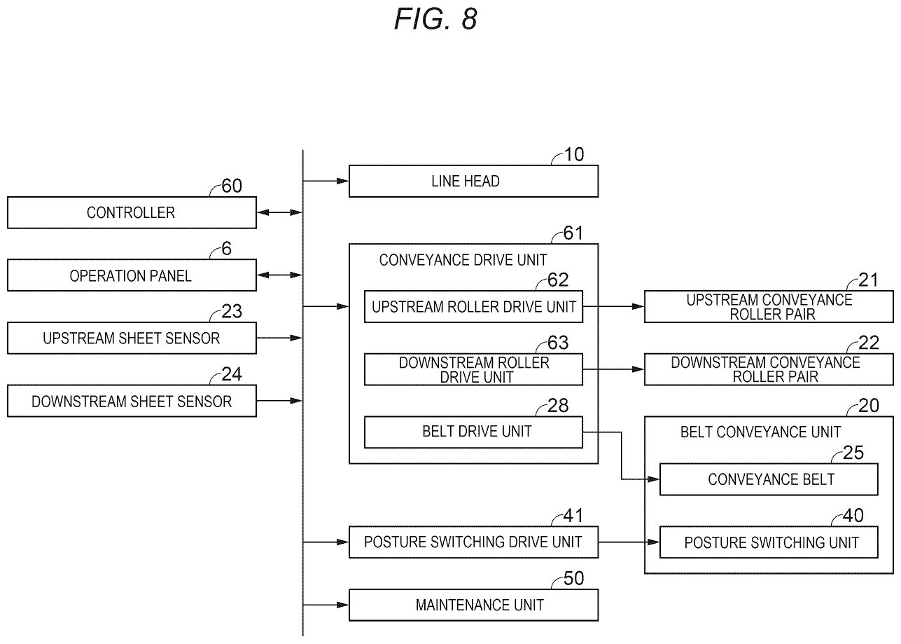

The conveyance path 11 is a path along which the sheet P is conveyed, and includes a feeding path 12, a straight path 13, and a face-down discharge path 14 in this order from the upstream side. The feeding path 12 is a path for picking up the sheet P from the sheet storage cassette 4 and conveying the sheet P toward the line head 10. The straight path 13 is a path that is connected to the feeding path 12, and in which recording is performed by the line head 10. The face-down discharge path 14 is a path that is connected to the straight path 13 to convey the sheet P on which recording was performed to the discharge unit 7. The conveyance of the sheet P is driven by a drive source such as a motor provided to a conveyance drive unit 61 (see FIG. 8). It should be noted that a direction in which the sheet P is conveyed from the upstream side to the downstream side of the conveyance path 11 is also referred to as a conveyance direction.

The printer 1 is capable of executing recording on both sides of the sheet P, so-called duplex recording. Specifically, the printer 1 includes a switchback path 15 that branches from the straight path 13 at the downstream side of the line head 10, and a reverse path 16 that is connected to the switchback path 15 and flips the sheet P. The reverse path 16 returns the sheet P to the straight path 13 at the upstream side of the line head 10. When duplex recording is performed, the sheet P on which recording has been performed on one surface is returned to the straight path 13 via the switchback path 15 and the reverse path 16, and recording on the opposite surface is performed.

The feeding path 12 is provided with a feeding roller 17 and a separation roller pair 18 that separates plural sheets P one by one in this order along the conveyance direction of the sheet P. The feeding roller 17 is rotationally driven by the conveyance drive unit 61. The separation roller pair 18 is also referred to as a retard roller, and is configured including a drive roller 18a that feeds the sheet P toward the straight path 13, and a driven roller 18b that nips the sheet P with the drive roller 18a. The drive roller rotationally driven by the conveyance drive unit 61.

Among plural sheets P accommodated in the sheet storage cassette 4, the uppermost sheet P is picked up by the feeding roller 17 and conveyed toward the downstream side in the conveyance direction. At this time, the second and subsequent sheets P are also picked up together with the uppermost sheet P in some cases. However, the uppermost sheet P and the second and subsequent sheets P are separated from each other by the separation roller pair 18, and only the uppermost sheet P is fed toward the downstream side.

The straight path 13 is configured as a path extending linearly, and the sheet P is conveyed in the +Y direction in the straight path 13. That is, the conveyance direction of the sheet P in the straight path 13 is the +Y direction. The straight path 13 includes a belt conveyance unit 20, an upstream conveyance roller pair 21, a downstream conveyance roller pair 22, an upstream sheet sensor 23, a downstream sheet sensor 24, and the line head 10. The straight path 13 is a path which includes a recording area in which recording is performed by the line head 10, and which extends from the recording area toward the +Y side and the −Y side of the line head 10. The belt conveyance unit 20, the upstream conveyance roller pair 21, and the downstream conveyance roller pair 22 that convey the sheet P in the straight path 13 correspond to a conveyance unit.

The belt conveyance unit 20 is disposed below the line head 10. Plural nozzles for ejecting the ink are formed on a nozzle surface which is a lower surface of the line head 10, and the belt conveyance unit 20 is disposed so as to be opposed to the nozzle surface of the line head 10. The belt conveyance unit 20 supports the sheet P subject to the ejection of the ink from the opposite side of the recording surface on which the ink is ejected. The belt conveyance unit 20 is an example of a support unit. A configuration of the belt conveyance unit 20 will be described later.

The line head 10 ejects ink onto the recording surface of the sheet P conveyed on the belt conveyance unit 20 to perform recording. The line head 10 is a recording head configured such that the plural nozzles cover the entire width of the sheet P, and is capable of performing recording on the entire width of the sheet P without moving in the width direction of the sheet P. It should be noted that the printer 1 according to the present embodiment includes the line head 10, but can be provided with a serial type recording head that is mounted on a carriage and performs recording by ejecting the ink onto the sheet P while reciprocating in the width direction of the sheet P.

The upstream conveyance roller pair 21 is located upstream in the conveyance direction of the line head 10 and the belt conveyance unit 20, and conveys the sheet P fed from the feeding path 12, to the belt conveyance unit 20. The downstream conveyance roller pair 22 is located downstream in the conveyance direction of the line head 10 and the belt conveyance unit 20, and conveys the recording sheet P on which recording was performed, from the belt conveyance unit 20 to the face-down discharge path 14 or the switchback path 15. Each of the upstream conveyance roller pair 21 and the downstream conveyance roller pair 22 is provided with a drive roller that is rotationally driven by the conveyance drive unit 61, and a driven roller that rotates so as to follow the drive roller, and conveys the sheet P in the +Y direction while nipping the sheet P by the drive roller and the driven roller. The drive rollers of the upstream conveyance roller pair 21 and the downstream conveyance roller pair 22 can be individually driven by the conveyance drive unit 61. The upstream conveyance roller pair 21 is an example of an upstream conveyance unit, and the downstream conveyance roller pair 22 is an example of a downstream conveyance unit.

The upstream sheet sensor 23 is disposed in the vicinity of the upstream side of the upstream conveyance roller pair 21, and the downstream sheet sensor 24 is disposed in the vicinity of the downstream side of the downstream conveyance roller pair 22. The upstream sheet sensor 23 and the downstream sheet sensor 24 are each configured using, for example, an optical sensor, and can detect the presence or absence of the sheet P to be conveyed. That is, the upstream sheet sensor 23 detects the sheet P at an upstream side of the upstream conveyance roller pair 21 in the conveyance direction, and the downstream sheet sensor 24 detects the sheet P at a downstream side of the downstream conveyance roller pair 22 in the conveyance direction. Although not shown in the drawings, plural sensors for detecting the presence or absence of the sheet P are disposed in the middle of the conveyance path 11 in addition to the upstream sheet sensor 23 and the downstream sheet sensor 24. The detection result by these sensors can be used when detecting the occurrence of the conveyance abnormality of the sheet P, such as a sheet jam, or when specifying the position where the conveyance abnormality occurred. The upstream sheet sensor 23 and the downstream sheet sensor 24 are each an example of a detection unit.

The face-down discharge path 14 is a curved path, and conveys the sheet P so as to be discharged from the discharge unit 7 with the recording surface of the sheet P recorded by the line head 10 face down. The sheet P that entered the face-down discharge path 14 is conveyed by plural conveyance roller pairs 30, and is then discharged from the discharge unit 7, and is at the same time placed on the medium placement portion 5 with the recording surface face down. Each of the plural conveyance roller pairs 30 is provided with a drive roller that is rotationally driven by the conveyance drive unit 61, and a driven roller that rotates so as to follow the drive roller, and nips and conveys the sheet P with the drive roller and the driven roller.

Rotation of plural drive rollers arranged along the conveyance path 11 is driven by a drive source such as a motor provided to the conveyance drive unit 61. The conveyance drive unit 61 includes plural drive sources, and is capable of driving the plural drive rollers in conjunction with each other or individually driving the plural drive rollers. As described above, the drive rollers of the upstream conveyance roller pair 21 and the downstream conveyance roller pair 22 provided to the straight path 13 can individually be driven by the conveyance drive unit 61. That is, the conveyance drive unit 61 is provided with an upstream roller drive unit 62 (see FIG. 8) as a drive source for driving the drive roller of the upstream conveyance roller pair 21, and is further provided with a downstream roller drive unit 63 (see FIG. 8) as a drive source for driving the drive roller of the downstream conveyance roller pair 22.

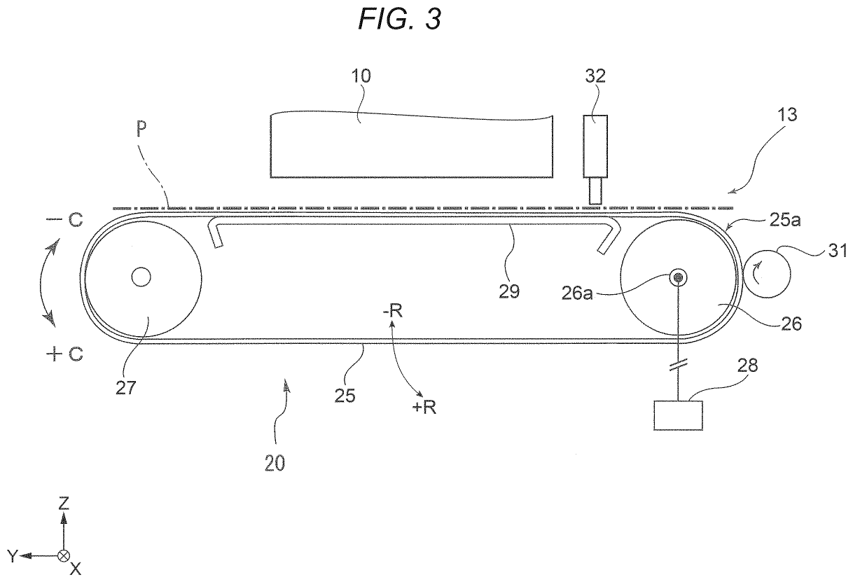

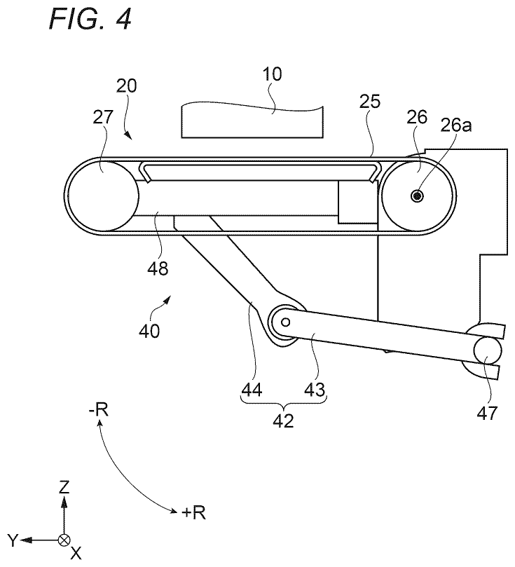

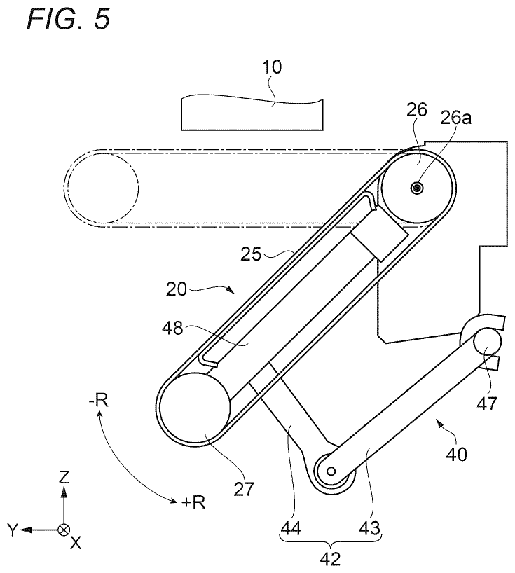

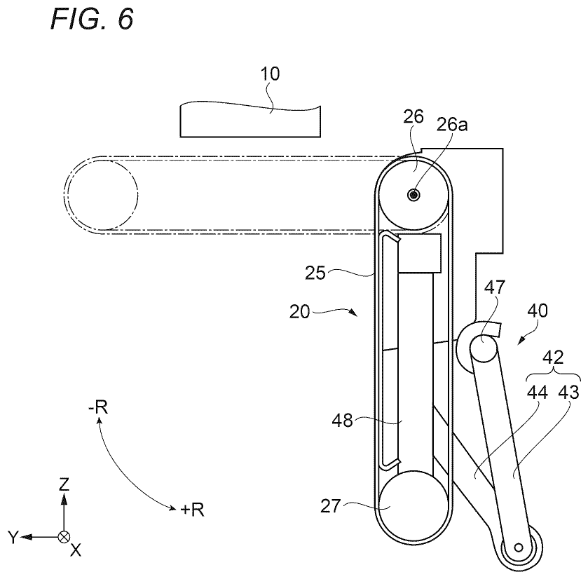

FIG. 3 is a side view illustrating a schematic configuration of the belt conveyance unit 20. Further, FIG. 4 through FIG. 6 are diagrams illustrating a posture of the belt conveyance unit 20, wherein FIG. 4 illustrates a diagram showing a first posture, FIG. 5 illustrates a diagram showing a second posture, and FIG. 6 illustrates a diagram showing a third posture.

As illustrated in FIG. 3, the belt conveyance unit 20 is provided with an endless conveyance belt 25, and an upstream pulley 26 and a downstream pulley 27 that are engaged by the conveyance belt 25. The belt conveyance unit 20 conveys the sheet P toward the +Y direction while attracting the sheet P to a belt outer surface 25a of the conveyance belt 25. The downstream pulley 27 is disposed downstream in the conveyance direction of the upstream pulley 26, that is, at the +Y side. The upstream pulley 26 and the downstream pulley 27 are rotatable taking an axis along the #X direction as a rotational axis.

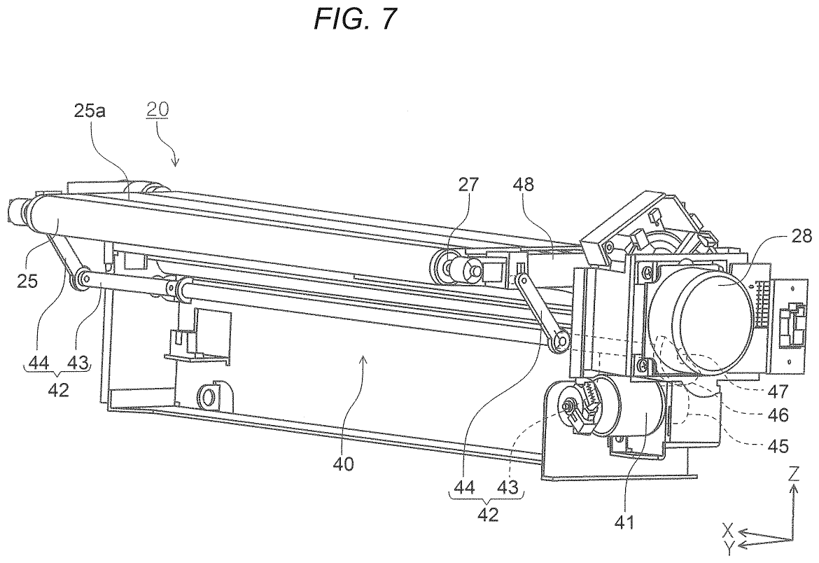

The conveyance drive unit 61 is provided with a belt drive unit 28 (see FIG. 7 and FIG. 8) including a drive source such as a motor, and the belt drive unit 28 circulates the conveyance belt 25 by rotationally driving the upstream pulley 26. On that occasion, the downstream pulley 27 is driven by the conveyance belt 25 thus circulating to thereby be rotated.

The belt drive unit 28 is configured to be capable of circulating the conveyance belt 25 in a +C direction and a-C direction as an opposite direction to the +C direction. The +C direction is a circulating direction when conveying the sheet P toward the +Y direction. In the belt outer surface 25a of the conveyance belt 25, a surface that travels toward the +Y direction when the conveyance belt 25 circulates toward the +C direction is hereinafter also referred to as a conveyance surface.

The belt conveyance unit 20 is configured to be rotatable in the +R direction and the −R direction as an opposite direction to the +R direction with a drive shaft 26a of the upstream pulley 26 along the +X direction as a rotational axis. That is, the rotational axis is located upstream in the conveyance direction of the center of the belt conveyance unit 20 in the conveyance direction. Further, by rotating around the drive shaft 26a as a rotational axis, the belt conveyance unit 20 is capable of switching the posture to one of a first posture (see FIG. 4) in which the conveyance surface of the conveyance belt 25 is substantially horizontal below the line head 10, a second posture (see FIG. 5) in which the conveyance surface of the conveyance belt 25 is obliquely inclined, and a third posture (see FIG. 6) in which the conveyance surface of the conveyance belt 25 is substantially parallel to the vertical direction. The first posture is a posture set when performing recording with the line head 10, and is a posture in which the sheet P can be conveyed toward the +Y direction while facing the nozzle surface of the line head 10. The second posture is a posture set to remove the sheet P in the process of recording when a conveyance abnormality or the like occurs. In the second posture, the conveyance surface of the conveyance belt 25 is inclined such that the downstream side is positioned lower than the upstream side in the conveyance direction. The third posture is a posture set when performing maintenance or the like of the line head 10 with the maintenance unit 50 described later.

It should be noted that the belt conveyance unit 20 changing the posture can be rephrased as the belt conveyance unit 20 changing the position. In this case, the belt conveyance unit 20 is capable of being displaced to one of a first position corresponding to the first posture, a second position corresponding to the second posture, and a third position corresponding to the third posture. Here, the first position is a position opposed to the nozzle surface of the line head 10, and the position where the belt conveyance unit 20 extends along the horizontal direction. Further, the second position is a position farther from the line head 10 than the first position, and is a position where the downstream side in the conveyance direction of the belt conveyance unit 20 moves downward in the vertical direction to thereby make the belt conveyance unit 20 be inclined. Further, the third position is a position farther from the line head 10 than the second position, and is a position where the belt conveyance unit 20 extends along the vertical direction.

In the present embodiment, the conveyance belt 25 is a belt that electrostatically adsorbs the sheet P to the belt outer surface 25a to convey the sheet P, and the belt conveyance unit 20 is provided with a charging roller 31 that charges the conveyance belt 25, and a destaticizing brush 32 that removes charges on the surface of the sheet P conveyed by the conveyance belt 25.

The charging roller 31 is disposed at the upstream side in the conveyance direction with respect to the destaticizing brush 32, and is disposed at a position opposed to the upstream pulley 26 below the straight path 13. The charging roller 31 makes contact with the belt outer surface 25a to apply a positive charge to the belt outer surface 25a. When the upstream pulley 26 and the downstream pulley 27 rotate and the conveyance belt 25 circulates in the +C direction, the belt outer surface 25a which the charging roller 31 made contact with, and which was charged forms a conveyance surface. Accordingly, the adsorptive property of the sheet P on the conveyance surface of the conveyance belt 25 is enhanced, and the sheet P can more effectively be adsorbed to the conveyance belt 25.

At the upstream side of the line head 10, the destaticizing brush 32 that makes contact with the sheet P is disposed, and the electric charges on the upper surface of the sheet P or the belt outer surface 25a are removed by the destaticizing brush 32. More specifically, when a positive charge is applied to the belt outer surface 25a of the conveyance belt 25 by the charging roller 31, a negative charge is generated on a surface having contact with the belt outer surface 25a, of the sheet P having contact with the belt outer surface 25a, and a positive charge is generated on the recording surface as the opposite surface. The electric charges on the recording surface side are removed by the destaticizing brush 32. Therefore, only the electric charges at a side of the sheet P where the sheet P has contact with the conveyance belt 25 are left, and as a result, the sheet P is adsorbed to the belt outer surface 25a. The destaticizing brush 32 can be made of any material as long as it is capable of removing electric charges from the sheet P and the conveyance belt 25, and can be made of a resin material such as conductive nylon.

In addition, the belt conveyance unit 20 is provided with a backup plate 29 that supports at least a part of the conveyance belt 25 from an inner surface side in an area between the upstream pulley 26 and the downstream pulley 27.

The belt conveyance unit 20 includes a posture switching unit 40 (see FIG. 4 through FIG. 6) that switches the posture of the belt conveyance unit 20 between the first posture, the second posture, and the third posture. The posture switching unit 40 switches the posture of the belt conveyance unit 20 by rotating the belt conveyance unit 20 in the +R direction with the drive shaft 26a of the upstream pulley 26 as the rotational axis.

The posture switching unit 40 is provided with a posture switching drive unit 41 (see FIG. 7 and FIG. 8) including a drive source such as a motor, and link members 2 that operate according to driving by the posture switching drive unit 41. The link members 42 are each configured including a first link plate 43 and a second link plate 44.

When the link members 42 rotate the belt conveyance unit 20 in the first posture by a predetermined angle in the +R direction with the drive shaft 26a as the rotational axis in response to the driving by the posture switching drive unit 41, the belt conveyance unit 20 takes the second posture. Further, when the link members 42 rotate the belt conveyance unit 20 in the second posture by the predetermined angle in the +R direction with the drive shaft 26a as the rotational axis, the belt conveyance unit 20 takes the third posture. The posture switching unit 40 can be capable of switching the posture of the belt conveyance unit 20 to a posture between the first posture and the second posture or a posture between the second posture and the third posture in addition to the first posture, the second posture, and the third posture.

FIG. 7 illustrates a perspective view showing the belt conveyance unit 20 in the first posture and the posture switching unit 40.

As illustrated in FIG. 7, the posture switching unit 40 is provided with a worm 45, a worm wheel 46, a shaft portion 47, and a base body 48. The worm 45 is fixed to a motor shaft not shown of the posture switching drive unit 41. The shaft portion 47 is a member extending in the ±X direction, and the worm wheel 46 engaged with the worm 45 is fixed to one end of the shaft portion 47. In other words, the shaft portion 47 rotates about its own central axis as a rotational axis in accordance with the driving by the posture switching drive unit 41. One ends of the first link plates 43 are fixed to the shaft portion 47 at two positions at a distance from each other in the ±X direction, and one ends of the second link plates 44 are rotatably attached to the other ends of the first link plates 43, respectively. Further, the other ends of the second link plates 44 are attached to the base body 48 that rotatably supports the upstream pulley 26 and the downstream pulley 27.

When the belt conveyance unit 20 is in the first posture, when the shaft portion 47 rotates counterclockwise when viewed from the −X side due to the driving by the posture switching drive unit 41, the link member 42 is folded such that the first link plates 43 and the second link plates 44 come closer to each other, and the belt conveyance unit 20 rotates in the +R direction to take the second posture. Further, when the shaft portion 47 further rotates counterclockwise when viewed from the −X side due to the driving by the posture switching drive unit 41 when the belt conveyance unit 20 is in the second posture, the belt conveyance unit 20 rotates in the +R direction to take the third posture.

Further, when the shaft portion 47 rotates in the reverse direction, that is, clockwise when viewed from the −X side due to the driving by the posture switching drive unit 41 when the belt conveyance unit 20 is in the third posture, the link members 42 open so that the first link plates 43 and the second link plates 44 get away from each other, and the belt conveyance unit 20 rotates in the −R direction to take the second posture. When the shaft portion 47 further rotates clockwise when viewed from the −X side due to the driving by the posture switching drive unit 41 when the belt conveyance unit 20 is in the second posture, the belt conveyance unit 20 rotates in the −R direction to take the first posture.

Returning to FIG. 2, the printer 1 is provided with a maintenance unit 50 that performs maintenance of the line head 10. The maintenance unit 50 performs maintenance operations such as flushing, capping, and suction cleaning in order to prevent or eliminate ejection failure caused by clogging of the nozzles and adhesion of a foreign matter to the nozzle surface. The maintenance unit 50 is provided with a cap 51, a waste liquid flow path 52, a suction pump 53 disposed in the middle of the waste liquid flow path 52, a moving mechanism 54, and a waste liquid container 55.

The moving mechanism 54 moves the cap 51 between a capping position where the cap 51 is capable of making contact with the nozzle surface of the line head 10, and a retracted position where the cap 51 is retracted from the capping position. When the cap 51 moves from the retracted position to the capping position, the belt conveyance unit 20 is switched from the first posture to the third posture.

The capping is an operation of moving the cap 51 to the capping position to cover the nozzle surface of the line head 10 with the cap 51. When the ejection of the ink is not performed, since the drying of the nozzles is prevented by performing the capping, an occurrence of the ejection failure can be prevented.

The flushing is an operation of forcibly ejecting the ink from the nozzles independently of the formation of an image to thereby discharge foreign matters, air bubbles, or modified ink which cause the ejection failure. The ink discharged as a waste liquid by the flushing can be received by the cap 51 or can also be received by a flushing box not shown separately provided.

The suction cleaning is an operation in which the suction pump 53 is driven in a state where the cap 51 is arranged at the capping position to thereby apply negative pressure to the nozzle, and thus discharge the ink from the nozzle by the negative pressure. The ink discharged from the nozzles by the suction cleaning is stored in the waste liquid container 55 through the waste liquid flow path 52 as the waste liquid. When the waste liquid discharged by flushing is received by the cap 51, the waste liquid received by the cap 51 can be accommodated in the waste liquid container 55 by driving the suction pump 53 in a state where the cap 51 is separated from the nozzle surface of the line head 10. When starting to use the printer 1, the nozzle is filled with ink by performing the suction cleaning.

FIG. 8 illustrates a block diagram showing a configuration of a control system of the printer 1.

As illustrated in FIG. 8, the printer 1 includes a controller 60. The controller 60 includes a processor not shown such as a CPU (Central Processing Unit), a storage device not shown such as a memory, and various interfaces, and controls various operations of the printer 1. The controller 60 controls the line head 10, the conveyance drive unit 61, the posture switching drive unit 41, the maintenance unit 50, and the operation panel 6 in accordance with a control program stored in the storage device. Further, the controller 60 is capable of controlling the belt conveyance unit 20, the upstream conveyance roller pair 21, and the downstream conveyance roller pair 22 constituting the conveyance unit described above via the posture switching drive unit 41 and the conveyance drive unit 61. Specifically, the controller 60 controls the posture switching unit 40 of the belt conveyance unit 20 with the posture switching drive unit 41, and controls the conveyance belt 25 of the belt conveyance unit 20 with the belt drive unit 28 provided to the conveyance drive unit 61. Further, the controller 60 controls the drive roller of the upstream conveyance roller pair 21 with the upstream roller drive unit 62 provided to the conveyance drive unit 61, and controls the drive roller of the downstream conveyance roller pair 22 with the downstream roller drive unit 63 provided to the conveyance drive unit 61. Further, detection results of plural sheet sensors including the upstream sheet sensor 23 and the downstream sheet sensor 24 described above are input to the controller 60.

The controller 60 in the present embodiment is capable of detecting a conveyance abnormality such as a sheet jam based on the detection result of the plural sheet sensors and the like. The conveyance abnormality can occur not only in the straight path 13 but also in the feeding path 12, the face-down discharge path 14, the switchback path 15, or the reverse path 16. In addition, when recording is continuously performed on the plural sheets P, the plural sheets P are simultaneously present in the conveyance path 11 in some cases, and the conveyance abnormality can occur in any of the sheets P. The controller 60 is capable of specifying the sheet P in which the conveyance abnormality occurred and the place where the conveyance abnormality occurred based on the detection results of the plural sheet sensors including the upstream sheet sensor 23 and the downstream sheet sensor 24.

Even when the conveyance abnormality occurs at any place, the controller 60 stops the conveyance in the entire conveyance path 11, and at the same time, stops the recording by the line head 10. That is, even when the conveyance abnormality occurs in the sheet P other than the sheet P conveyed by the belt conveyance unit 20, the recording on the sheet P on the belt conveyance unit 20 stops in the middle. Therefore, even when the conveyance abnormality occurs at any place, the user needs to remove the sheet P on the belt conveyance unit 20. It should be noted that the conveyance can be continued for the sheet P located downstream in the conveyance direction of the place where the conveyance abnormality occurs. However, even in this case, when a conveyance abnormality occurs in the sheet P located downstream of the sheet P conveyed by the belt conveyance unit 20, the recording on the sheet P on the belt conveyance unit 20 stops in the middle.

Further, when the conveyance abnormality occurs, in order to facilitate removal of the sheet P on the belt conveyance unit 20, it is preferred to set the posture of the belt conveyance unit 20 to the second posture or the third posture to form a large space below the line head 10. It should be noted that when an end portion of the sheet P hangs down into the space, there is a possibility that the ink immediately after being ejected onto the sheet P from the line head 10 flows down to stain the inside of the printer 1. In particular, when the ink is ejected in a state where the conveyance of the sheet P is stopped, a large amount of ink is accumulated in one portion of the sheet P, and thus the possibility that the ink flows down increases. Further, there is also a possibility that the printer 1 breaks down due to the fact that the dropped ink adheres to various members in the printer 1.

Therefore, when the conveyance is stopped due to the conveyance abnormality or the like in a state where at least a part of the sheet P is supported by the belt conveyance unit 20, the controller 60 of the present embodiment controls the conveyance drive unit 61 and the posture switching drive unit 41 to hold the sheet P in a predetermined posture so that the end portion of the sheet P does not hang down. Specifically, the controller 60 controls the belt conveyance unit 20, the upstream conveyance roller pair 21, and the downstream conveyance roller pair 22 such that the sheet P forms a curve convex downward in the vertical direction.

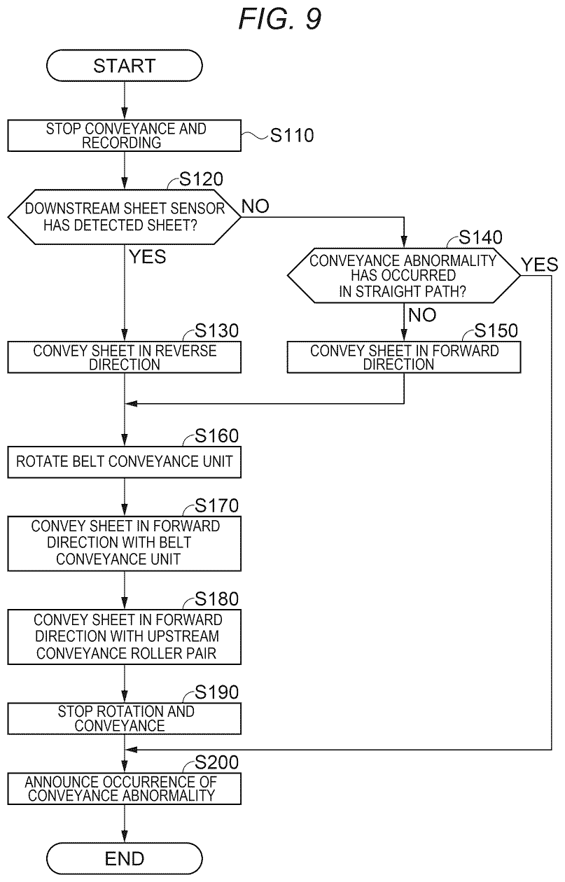

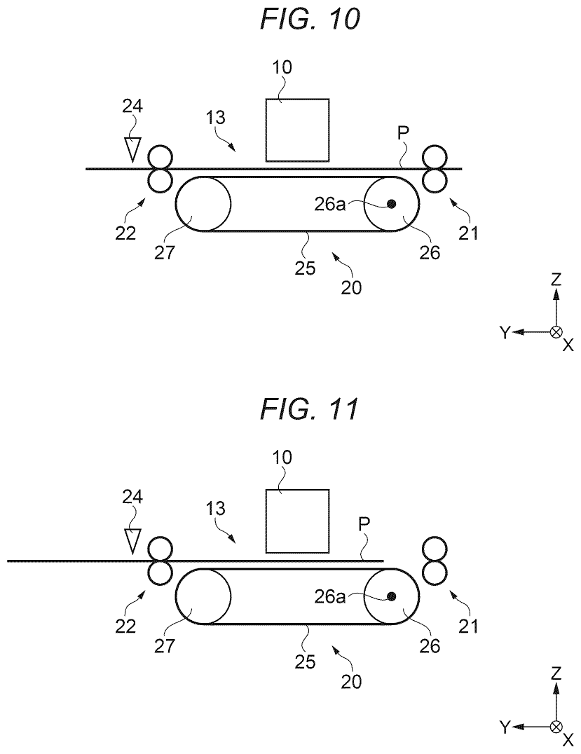

FIG. 9 illustrates a flowchart showing the operation of the printer 1 when the conveyance abnormality occurs. FIG. 10 through FIG. 17 are each a side view showing a state of the belt conveyance unit 20 and the sheet P.

The controller 60 of the printer 1 operates according to the flow shown in FIG. 9 when the occurrence of a conveyance abnormality such as a sheet jam is detected based on the detection results of the plural sheet sensors including the upstream sheet sensor 23 and the downstream sheet sensor 24. Specifically, when the conveyance abnormality occurs in any of sheets P on the conveyance path 11 in a state where at least a part of one of the sheets P located on the conveyance path 11 is supported by the belt conveyance unit 20, the controller 60 operates in accordance with the flow shown in FIG. 9. It should be noted that the +Y direction that is the original conveyance direction of the sheet P in the straight path 13 is hereinafter also referred to as a forward direction, and the −Y direction that is the opposite direction is hereinafter also referred to as a reverse direction. Further, the belt conveyance unit 20 circulating the conveyance belt 25 in the +C direction has the same meaning as the belt conveyance unit 20 conveying the sheet P in the forward direction, and the belt conveyance unit 20 circulating the conveyance belt 25 in the −C direction has the same meaning as the belt conveyance unit 20 conveying the sheet P in the reverse direction.

As illustrated in FIG. 9, first, in step S110, upon receipt of the occurrence of the conveyance abnormality, the controller 60 stops the conveyance of the sheet P by the conveyance drive unit 61 and the recording on the sheet P by the line head 10. As a result, driving of the upstream conveyance roller pair 21 by the upstream roller drive unit 62, driving of the downstream conveyance roller pair 22 by the downstream roller drive unit 63, and driving of the belt conveyance unit 20 by the belt drive unit 28 are stopped.

In step S120, the controller 60 determines whether the downstream sheet sensor 24 has detected the sheet P in a state where the conveyance of the sheet P is stopped. For example, as illustrated in FIG. 10 and FIG. 11, when the downstream sheet sensor 24 has detected the sheet P, it is assumed that the sheet P is nipped by the downstream conveyance roller pair 22. It should be noted that FIG. 10 illustrates a state in which both the upstream conveyance roller pair 21 and the downstream conveyance roller pair 22 nip the sheet P on the belt conveyance unit 20. Further, FIG. 11 illustrates a state in which the downstream conveyance roller pair 22 nips the sheet P while the upstream conveyance roller pair 21 does not nip the sheet P. When the downstream sheet sensor 24 has detected the sheet P (step S120: YES), the controller 60 makes the transition of the process to step S130, and when the downstream sheet sensor 24 has failed to detect the sheet P (step S120: NO), the controller 60 makes the transition of the process to step S140.

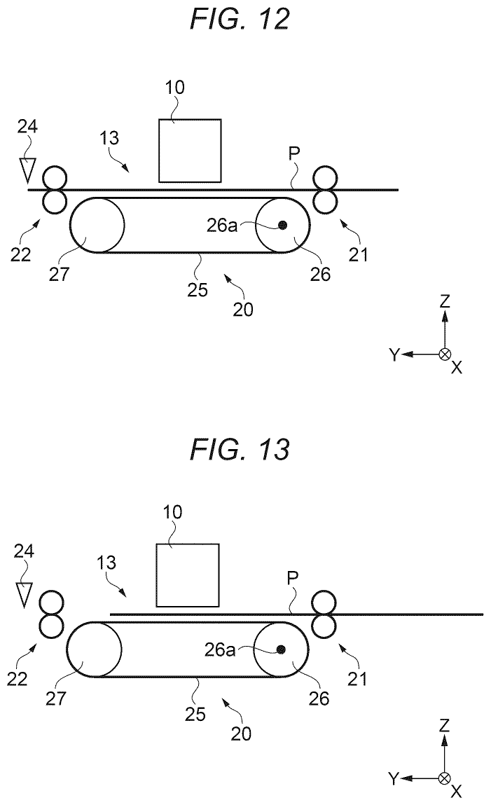

When the downstream sheet sensor 24 has detected the sheet P and thus the process has proceeded to step S130, the controller 60 controls the conveyance drive unit 61 to convey the sheet P on the belt conveyance unit 20 toward the −Y direction, which is the reverse direction, with the belt conveyance unit 20, the upstream conveyance roller pair 21, and the downstream conveyance roller pair 22. Then, immediately before the end portion of the sheet P at the +Y side passes immediately below the downstream sheet sensor 24, that is, immediately before the downstream sheet sensor 24 becomes unable to detect the sheet P, the controller 60 stops the conveyance in the reverse direction. In other words, the controller 60 conveys the sheet P in the reverse direction within a range in which the downstream sheet sensor 24 can detect the sheet P. Thus, as shown in FIG. 12, the sheet P comes into the state of being nipped by the downstream conveyance roller pair 22 in a vicinity of the end portion at the +Y side.

It should be noted that the controller 60 is capable of grasping the position of the sheet P based on the timing at which feeding of the sheet P is started, the timing at which the sheet P passes through the upstream sheet sensor 23, and so on. Therefore, the controller 60 can stop the conveyance in the reverse direction at a position immediately before the downstream sheet sensor 24 becomes unable to detect the sheet P, without using the detection result by the downstream sheet sensor 24. It should be noted that the controller 60 can stop the conveyance in the reverse direction based on the detection result by the downstream sheet sensor 24. In this case, it is necessary to convey the sheet P by a predetermined amount in the forward direction so that the end portion at the +Y side of the sheet P to be conveyed in the reverse direction is detected by the downstream sheet sensor 24 after passing directly below the downstream sheet sensor 24 and the downstream sheet sensor 24 becomes unable to detect the sheet P.

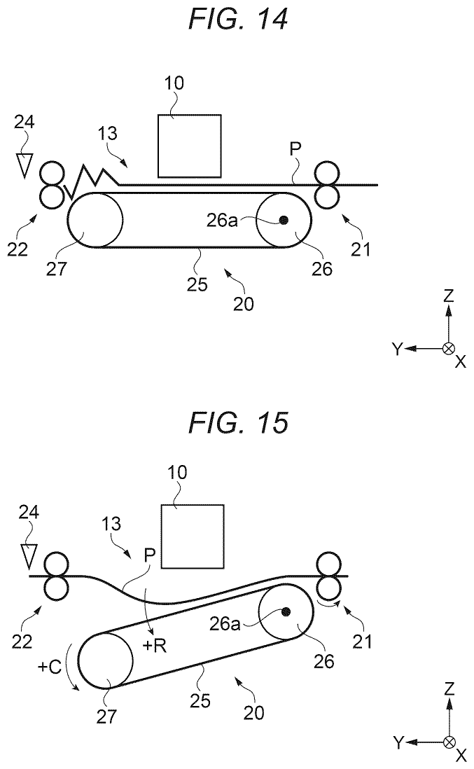

On the other hand, when the downstream sheet sensor 24 has not detected the sheet P in a state where the conveyance of the sheet P is stopped due to the conveyance abnormality, and thus the process has proceeded to step S140, the controller 60 determines whether the position where the conveyance abnormality has occurred is the straight path 13. As a situation in which the downstream sheet sensor 24 fails to detect the sheet P, for example, it is conceivable when a sheet jam occurs in the downstream conveyance roller pair 22 as illustrated in FIG. 14, in addition to when the end portion at the +Y side of the sheet P does not reach the downstream conveyance roller pair 22 as illustrated in FIG. 13. Therefore, when the downstream sheet sensor 24 has not detected the sheet P in spite of the timing at which the end portion at the +Y side of the sheet P should pass the downstream sheet sensor 24, the controller 60 determines that a conveyance abnormality such as a sheet jam has occurred in the straight path 13. The controller 60 makes the transition of the process to step S150 when the conveyance abnormality has occurred in a path other than the straight path 13 (step S140: NO), and makes the transition of the process to step S200 when the conveyance abnormality has occurred in the straight path 13 (step S140: YES).

When the position where the conveyance abnormality has occurred is other than the straight path 13 and thus the process proceeds to step S150, the controller 60 controls the conveyance drive unit 61 to convey the sheet P toward the +Y direction which is the forward direction. Then, immediately after the end portion at the +Y side of the sheet P passes immediately below the downstream sheet sensor 24, that is, immediately after the downstream sheet sensor 24 becomes able to detect the sheet P, the controller 60 stops the conveyance in the forward direction. That is, the controller 60 conveys the sheet P in the forward direction until the downstream sheet sensor 24 successfully detects the sheet P. Thus, the sheet P comes into the same state as the state illustrated in FIG. 12, that is, the state where the vicinity of the end portion at the +Y side is nipped by the downstream conveyance roller pair 22. Subsequently, the controller 60 makes the transition of the process to step S160.

It should be noted that as illustrated in FIG. 14, when the sheet P is conveyed in the forward direction in a situation where the conveyance abnormality occurs in the straight path 13, there is a possibility that the sheet P makes contact with the nozzle surface of the line head 10. Therefore, when the conveyance abnormality occurs in the straight path 13 (step S140: YES), the process is made to proceed to step S200 without performing the operation in step S150 and the operations in step S160 through S190 described later.

After the vicinity of the end portion at the +Y side of the sheet P comes into the state of being nipped by the downstream conveyance roller pair 22 through step S130 or step S150, the controller 60 controls the posture switching drive unit 41 to start the rotation of the belt conveyance unit 20 in the +R direction in step S160 in order to change the posture of the belt conveyance unit 20 from the first posture to the second posture.

Further, in step S170, the controller 60 controls the belt drive unit 28 to circulate the conveyance belt 25 of the belt conveyance unit 20 in the +C direction to convey the sheet P in the forward direction.

Further, in step S180, the controller 60 controls the upstream roller drive unit 62 to convey the sheet P in the forward direction with the upstream conveyance roller pair 21. While the belt conveyance unit 20 and the upstream conveyance roller pair 21 convey the sheet P in the forward direction, the rotation of the downstream conveyance roller pair 22 remains stopped.

Here, although the strict start order of steps S160, S170, and S180 does not matter, it is preferable for these steps to be performed substantially simultaneously in parallel. That is, it is preferable that the upstream conveyance roller pair 21 and the belt conveyance unit 20 convey the sheet P in the forward direction while the belt conveyance unit 20 rotates in the +R direction. Further, these steps can be performed simultaneously with step S130 or step S150.

This is because, when the conveyance by the upstream conveyance roller pair 21 and the belt conveyance unit 20 significantly precedes the rotation in the +R direction of the belt conveyance unit 20, there is a possibility that the sheet P undulates to make contact with the nozzle surface of the line head 10. Further, this is because, when the rotation in the +R direction of the belt conveyance unit 20 significantly precedes the conveyance by the upstream conveyance roller pair 21 and the belt conveyance unit 20, there is a possibility that the suction of the sheet P is released, and it becomes unachievable to appropriately convey the sheet P.

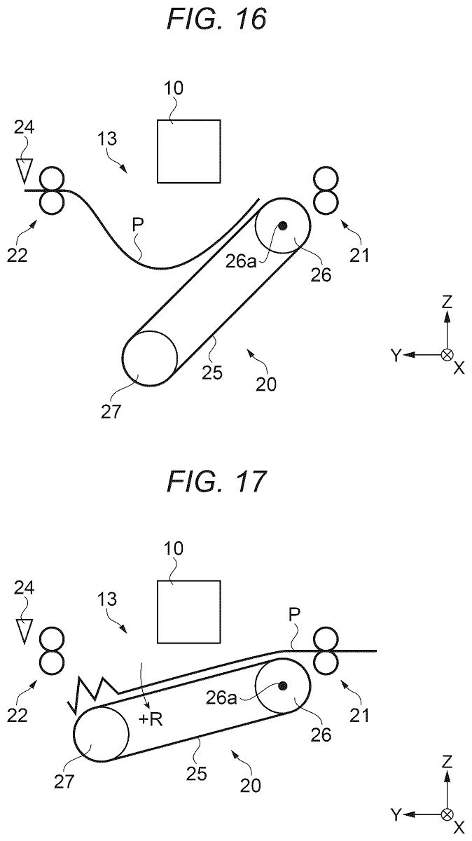

As shown in FIG. 15, when the sheet P is conveyed in the forward direction by the belt conveyance unit 20 and the upstream conveyance roller pair 21 while rotating the belt conveyance unit 20 in the +R direction, the sheet P starts to gradually form a curve convex downward in the vertical direction. Then, as shown in FIG. 16, when the posture of the belt conveyance unit 20 becomes the second posture, and further, when the end portion at the −Y side of the sheet P passes the upstream conveyance roller pair 21 to reach an area above the belt conveyance unit 20, the sheet P forms a greatly curved shape.

In step S190, the controller 60 controls the posture switching drive unit 41 and the conveyance drive unit 61 to stop the rotation of the belt conveyance unit 20 and the conveyance by the upstream conveyance roller pair 21 and the belt conveyance unit 20. Specifically, when the posture of the belt conveyance unit 20 becomes the second posture, the controller 60 controls the posture switching drive unit 41 to stop the rotation of the belt conveyance unit 20. Further, when the end portion at the −Y side of the sheet P passes through the upstream conveyance roller pair 21 to reach an area above the belt conveyance unit 20, the controller 60 controls the conveyance drive unit 61 to stop the conveyance by the upstream conveyance roller pair 21 and the belt conveyance unit 20. On this occasion, since the end portion at the downstream side of the sheet P in the conveyance direction is supported by the downstream conveyance roller pair 22, and the end portion at the upstream side of the sheet P in the conveyance direction is supported by the belt conveyance unit 20 in the second posture, the sheet P forms a curve convex downward in the vertical direction. As described above, in the present embodiment, the controller 60 controls the belt conveyance unit 20, the upstream conveyance roller pair 21, and the downstream conveyance roller pair 22 such that the sheet P forms the curve in the state where the downstream sheet sensor 24 has detected the sheet P when the conveyance of the sheet P stops due to the conveyance abnormality or the like.

When the process proceeds to step S200 via step S140 or step S190, the controller 60 displays a message on the operation panel 6 to notify the user of the occurrence of the conveyance abnormality, and a completion of the preparation for removing the sheet P remaining in the straight path 13, and then ends the process. When this message is displayed, the user opens the front cover 8 of the apparatus body 2 to remove the sheet P. On this occasion, the controller 60 can detect whether the removal of the sheet P has been completed, based on the detection result by the downstream sheet sensor 24, except when the conveyance abnormality has occurred in the straight path 13.

It should be noted that the occurrence of the conveyance abnormality and the completion of the preparation for removing the sheet P can be announced at respective timings different from each other. Further, the printer 1 can be provided with a lock mechanism that restricts opening and closing of the front cover 8 under the control of the controller 60. In this case, the controller 60 can make the front cover 8 unopenable until the sheet P forms the curve, and can release the lock after the sheet P forms the curve to make the front cover 8 openable.

Further, in the above embodiment, when the conveyance abnormality occurs in the straight path 13 (step S140: YES), the downstream conveyance roller pair 22 is unachievable to support the sheet P, and unachievable to provide the curve to the sheet P, and therefore, the operations in steps S160 through S190 are omitted. However, as shown in FIG. 14, when the conveyance abnormality such as a sheet jam occurs in the straight path 13, it is assumed that one or more fold lines are formed along the width direction in a downstream region of the sheet P. In this case, even when the sheet P is inclined to a certain degree, the ink immediately after being ejected onto the sheet P is blocked by the bent portion of the sheet P, and is therefore difficult to flow downward. Therefore, as shown in FIG. 17, when the conveyance abnormality occurs in the straight path 13, it is possible to make the belt conveyance unit 20 rotate by a predetermined amount in the +R direction. Accordingly, since the space below the line head 10 is widened compared to when the belt conveyance unit 20 is not rotated, it becomes easy to remove the sheet P. The posture of the belt conveyance unit 20 in this case can be the same as the second posture, or can be a posture inclined more gently than the second posture.

As described hereinabove, according to the printer 1 of the present embodiment, the following advantages can be obtained.

In the printer 1 according to the present embodiment, when the conveyance stops in the state in which at least a part of the sheet P is supported by the belt conveyance unit 20, the controller 60 controls the belt conveyance unit 20, the upstream conveyance roller pair 21, and the downstream conveyance roller pair 22 so that the belt conveyance unit 20 is separated from the line head 10 by bringing the belt conveyance unit 20 into the second posture, and the sheet P forms the curve convex downward in the vertical direction.

According to this configuration, since the sheet P forms the curve convex downward, it becomes possible to retain the ink ejected onto the sheet P in the curved portion. In other words, it is possible to prevent the ink ejected onto the sheet P from flowing down from the sheet P to stain the inside of the printer 1.

In addition, in the printer 1 according to the present embodiment, the belt conveyance unit 20 is switched from the first posture to the second posture by rotating around the drive shaft 26a located upstream in the conveyance direction of the center of the belt conveyance unit 20 as the rotational axis. In other words, the conveyance surface of the belt conveyance unit 20 is inclined when the downstream side in the conveyance direction moves downward in the vertical direction. Then, the sheet P is supported by the downstream conveyance roller pair 22 and the belt conveyance unit 20 in the second posture, to thereby form the curve.

According to this configuration, it is possible to easily form the curve convex downward by supporting the sheet P with the belt conveyance unit 20 thus inclined and the downstream conveyance roller pair 22 when the rotational axis of the belt conveyance unit 20 is located at the upstream side. Further, in this state, since the upstream end portion of the sheet P on which no ink is ejected with probability passes the upstream conveyance roller pair 21 and is then located on the belt conveyance unit 20, it is possible to prevent the hand from being contaminated by handling the end portion when removing the sheet P.

Further, the printer 1 according to the present embodiment is further provided with the downstream sheet sensor 24 that detects the sheet P downstream in the conveyance direction of the downstream conveyance roller pair 22, and when the conveyance stops, the controller 60 controls the belt conveyance unit 20, the upstream conveyance roller pair 21, and the downstream conveyance roller pair 22 such that the sheet P forms the curve in the state where the downstream sheet sensor 24 has detected the sheet P.

According to this configuration, by forming the curve in the state where the downstream sheet sensor 24 has detected the sheet P, it is possible to achieve the state where the sheet P is supported by the downstream conveyance roller pair 22 and the belt conveyance unit 20. Further, by keeping the state where the downstream sheet sensor 24 has detected the sheet P, it is possible to detect the removal of the sheet P.

Further, in the printer 1 according to the present embodiment, when the downstream sheet sensor 24 has not detected the sheet P when the conveyance stops, the controller 60 makes the belt conveyance unit 20, the upstream conveyance roller pair 21, and the downstream conveyance roller pair 22 convey the sheet P in the conveyance direction until the downstream sheet sensor 24 successfully detects the sheet P.

According to this configuration, when the downstream sheet sensor 24 fails to detect the sheet P, it is possible to keep the state where the sheet P is supported by the downstream conveyance roller pair 22 by conveying the sheet P in the conveyance direction until the downstream sheet sensor 24 successfully detects the sheet P.

Further, in the printer 1 according to the present embodiment, when the downstream sheet sensor 24 has detected the sheet P when the conveyance stops, the controller 60 makes the belt conveyance unit 20, the upstream conveyance roller pair 21, and the downstream conveyance roller pair 22 convey the sheet P in the direction opposite to the conveyance direction within a range in which the downstream sheet sensor 24 can detect the sheet P.

According to this configuration, since the downstream conveyance roller pair 22 supports the downstream end portion of the sheet P as a result, even the sheet P short in length can form the curve.

In addition, in the printer 1 according to the present embodiment, the belt conveyance unit 20 is provided with the conveyance belt 25 for adsorbing and conveying the sheet P, and the controller 60 controls the conveyance belt 25 when forming the curve.

According to this configuration, by controlling the conveyance belt 25, it is possible to more easily form the curve.

Further, in the printer 1 according to the present embodiment, the controller 60 notifies the user of the occurrence of an abnormality after the sheet P forms the curve.

According to this configuration, by performing the notification after the sheet P forms the curve, the user can know that the removal of the sheet P has become possible.

Further, in the printer 1 according to the present embodiment, the belt conveyance unit 20 can be switched to the third posture at a longer distance from the line head 10 than the second posture.

According to this configuration, by separating the belt conveyance unit 20 at a long distance from the line head 10, it is possible to prevent the belt conveyance unit 20 from interfering with the maintenance or the like of the line head 10.

Further, in the method for controlling the printer 1 according to the present embodiment, when the downstream sheet sensor 24 has not detected the sheet P when the conveyance stops in the state where at least a part of the sheet P is supported by the belt conveyance unit 20, the sheet P is conveyed in the conveyance direction until the downstream sheet sensor 24 successfully detects the sheet P. On the other hand, when the downstream sheet sensor 24 has detected the sheet P when the conveyance stops in the state where at least a part of the sheet P is supported by the belt conveyance unit 20, the sheet P is conveyed in the direction opposite to the conveyance direction within the range in which the downstream sheet sensor 24 can detect the sheet P. Then, the belt conveyance unit 20 is rotated around the rotational axis located upstream in the conveyance direction of the center in the conveyance direction of the belt conveyance unit 20 to thereby be separated from the line head 10, and then the upstream conveyance roller pair 21 and the belt conveyance unit 20 are controlled such that the sheet P is supported by the downstream conveyance roller pair 22 and the belt conveyance unit 20 to thereby form the curve convex downward in the vertical direction.

According to this control method, since the sheet P forms the curve convex downward, it becomes possible to retain the ink ejected onto the sheet P in the curved portion. In other words, it is possible to prevent the ink ejected onto the sheet P from flowing down from the sheet P to stain the inside of the printer 1.

### 2. Second Embodiment

A printer 1 according to a second embodiment will hereinafter be described with reference to the drawings.

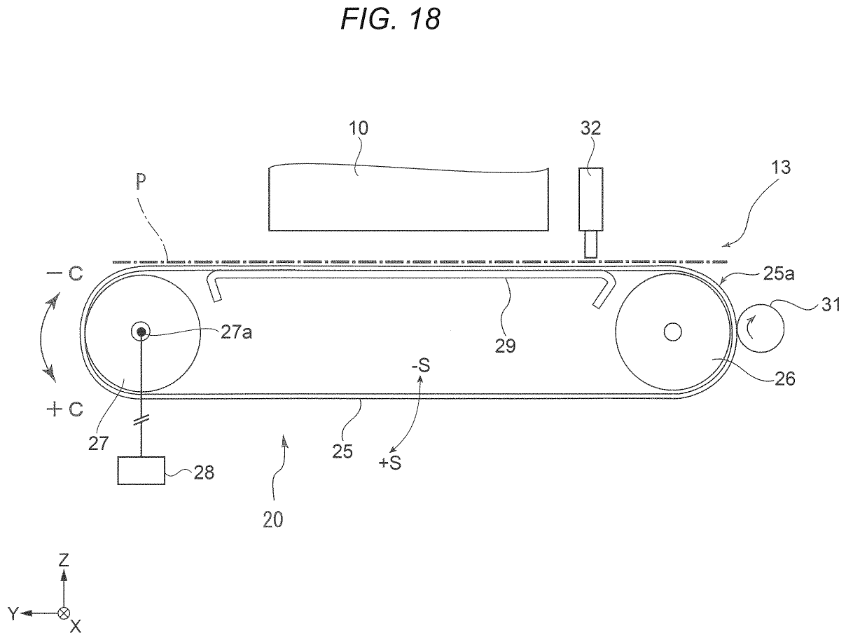

FIG. 18 is a side view illustrating a schematic configuration of the belt conveyance unit 20 related to the second embodiment.

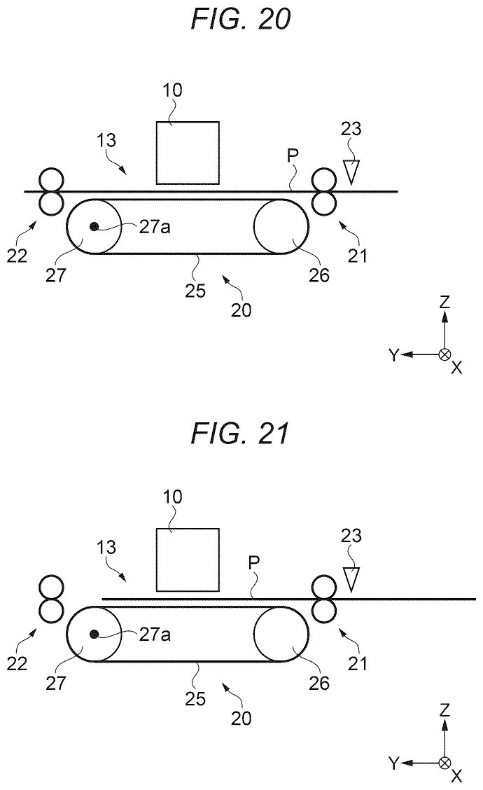

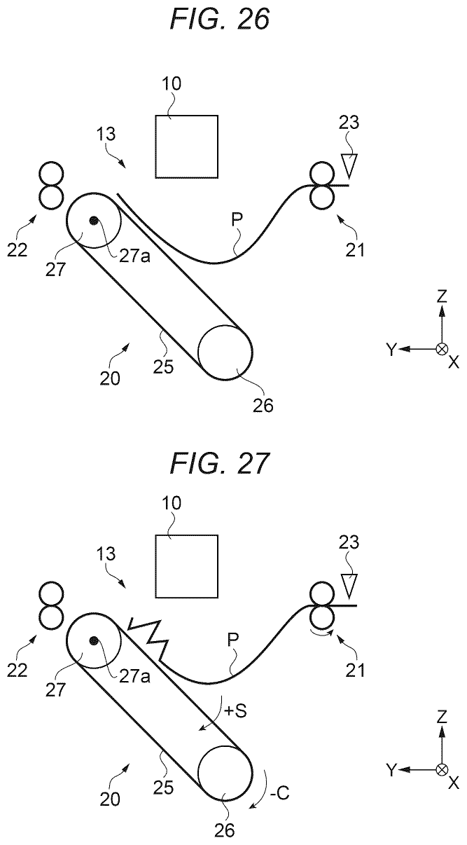

As shown in FIG. 18, the belt conveyance unit 20 in the present embodiment is different from that in the first embodiment in that the downstream pulley 27 is rotationally driven by the belt drive unit 28. Further, unlike the first embodiment, the belt conveyance unit 20 in the present embodiment is configured to be rotatable in a +S direction and a-S direction that is opposite to the +S direction with a drive shaft 27a of the downstream pulley 27 as the rotational axis. That is, the rotational axis in the present embodiment is located downstream in the conveyance direction of the center in the conveyance direction of the belt conveyance unit 20. Further, similarly to the first embodiment, the belt conveyance unit 20 is capable of switching the posture between a first posture (see FIG. 20) in which the conveyance surface of the conveyance belt 25 is substantially horizontal at a position below the line head 10, a second posture (see FIG. 26) in which the conveyance surface of the conveyance belt 25 is inclined obliquely, and a third posture (not illustrated) in which the conveyance surface of the conveyance belt 25 is substantially parallel to the vertical direction. The first posture is a posture that is set when recording is performed by the line head 10, and is a posture in which the sheet P can be conveyed toward the +Y direction. The second posture is a posture set to remove the sheet P in the process of recording when a conveyance abnormality or the like occurs. In the second posture, the conveyance surface of the conveyance belt 25 is inclined such that the upstream side is positioned lower than the downstream side in the conveyance direction. The third posture is a posture set when maintenance or the like of the line head 10 is performed by the maintenance unit 50.

Similarly to the first embodiment, the belt conveyance unit 20 changing the posture can be rephrased as the belt conveyance unit 20 changing the position. That is, the belt conveyance unit 20 can be displaced between a first position corresponding to the first posture, a second position corresponding to the second posture, and a third position corresponding to the third posture. Here, the first position is a position opposed to the nozzle surface of the line head 10, and the position where the belt conveyance unit 20 extends along the horizontal direction. Further, the second position is a position farther from the line head 10 than the first position, and is a position where the belt conveyance unit 20 is inclined when the upstream in the conveyance direction of the belt conveyance unit 20 moves downward in the vertical direction. Further, the third position is a position farther from the line head 10 than the second position, and is a position where the belt conveyance unit 20 extends along the vertical direction.

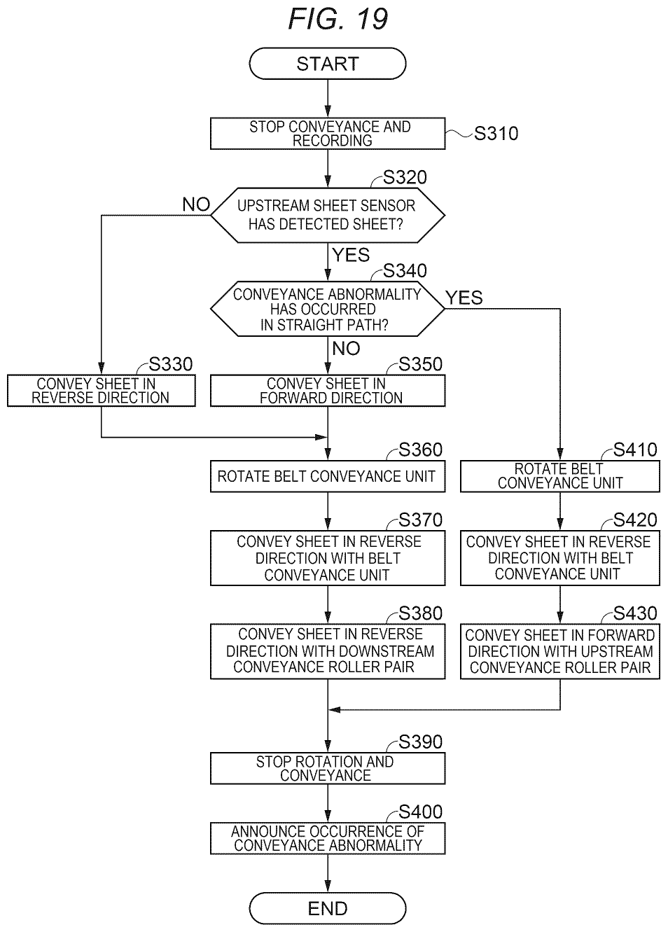

FIG. 19 illustrates a flowchart showing the operation of the printer 1 when a conveyance abnormality occurs in the second embodiment. FIG. 20 through FIG. 27 are each a side view illustrating the states of the belt conveyance unit 20 and the sheet P.

The controller 60 of the printer 1 operates according to the flow illustrated in FIG. 19 when the occurrence of the conveyance abnormality such as a sheet jam has been detected based on the detection result of the plural sheet sensors including the upstream sheet sensor 23 and the downstream sheet sensor 24.

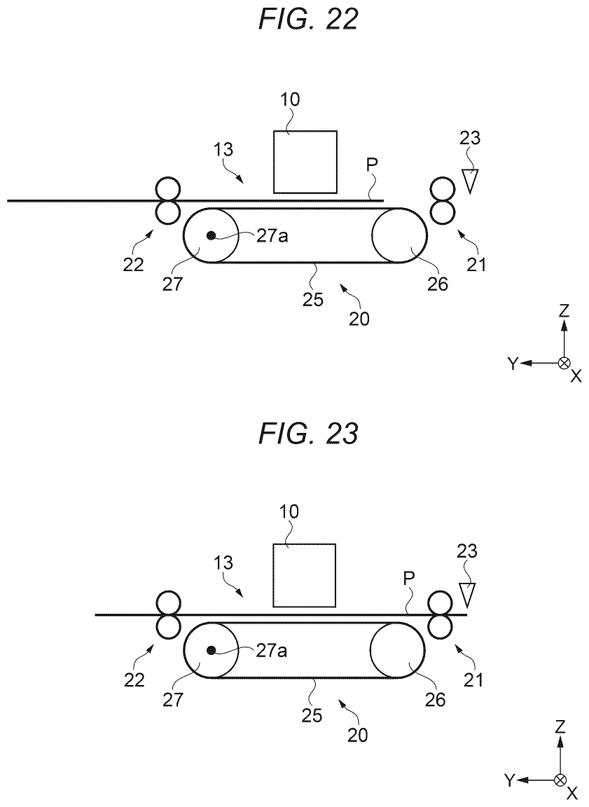

As shown in FIG. 19, first, in step S310, upon receipt of the occurrence of the conveyance abnormality, the controller 60 stops the conveyance of the sheet P by the conveyance drive unit 61 and the recording of the sheet P by the line head 10. As a result, driving of the upstream conveyance roller pair 21 by the upstream roller drive unit 62, driving of the downstream conveyance roller pair 22 by the downstream roller drive unit 63, and driving of the belt conveyance unit 20 by the belt drive unit 28 are stopped. In step S320, the controller 60 determines whether the upstream sheet sensor 23 has detected the sheet P in the state where the conveyance of the sheet P stops. For example, as illustrated in FIG. 20 and FIG. 21, when the upstream sheet sensor 23 has detected the sheet P, it is assumed that the sheet P is nipped by the upstream conveyance roller pair 21. It should be noted that FIG. 20 illustrates a state in which both the upstream conveyance roller pair 21 and the downstream conveyance roller pair 22 nip the sheet P on the belt conveyance unit 20. Further, FIG. 21 illustrates a state in which the upstream conveyance roller pair 21 nips the sheet P, and the downstream conveyance roller pair 22 does not nip the sheet P. When the upstream sheet sensor 23 has detected the sheet P (step S320: YES), the controller 60 makes the transition of the process to step S340. On the other hand, as illustrated in FIG. 22, when the upstream sheet sensor 23 has not detected the sheet P (step S320: NO), the controller 60 makes the transition of the process to step S330.

When the upstream sheet sensor 23 has not detected the sheet P and the process has proceeded to step S330, the controller 60 controls the conveyance drive unit 61 to convey the sheet P toward the −Y direction which is the reverse direction. Then, immediately after the end portion at the −Y side of the sheet passes immediately below the upstream sheet sensor 23, that is, immediately after the upstream sheet sensor 23 becomes capable of detecting the sheet P, the controller 60 stops the conveyance in the reverse direction. In other words, the controller 60 conveys the sheet P in the reverse direction until the upstream sheet sensor 23 successfully detects the sheet P. As a result, as illustrated in FIG. 23, the sheet P comes into the state in which the vicinity of the end portion at the −Y side is nipped by the upstream conveyance roller pair 21. Subsequently, the controller 60 makes the transition of the process to step S360.

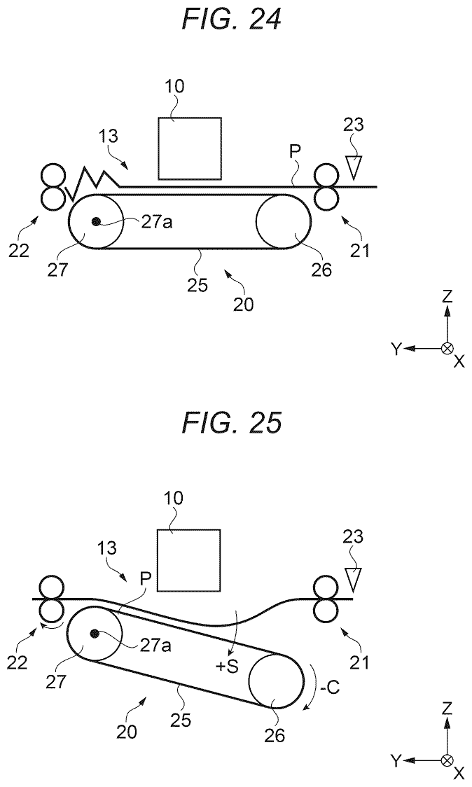

On the other hand, when the upstream sheet sensor 23 has detected the sheet P and the process has proceeded to step S340 in the state where the conveyance of the sheet P stops due to an occurrence of the conveyance abnormality, the controller 60 determines whether the position where the conveyance abnormality has occurred is in the straight path 13. As a situation in which the upstream sheet sensor 23 has detected the sheet P, there is conceivable when, for example, a sheet jam occurs in the downstream conveyance roller pair 22 as illustrated in FIG. 24 in addition to the cases illustrated in FIG. 20 and FIG. 21. Therefore, when the downstream sheet sensor 24 has not detected the sheet P in spite of the timing at which the end portion at the +Y side of the sheet P should pass the downstream sheet sensor 24, the controller 60 determines that a conveyance abnormality such as a sheet jam has occurred in the straight path 13. The controller 60 makes the transition of the process to step S350 when the conveyance abnormality has occurred in a path other than the straight path 13 (step S340: NO), and makes the transition of the process to step S410 when the conveyance abnormality has occurred in the straight path 13 (step S340: YES).

When the position where the conveyance abnormality has occurred is other than the straight path 13 and the process has proceeded to step S350, the controller 60 controls the conveyance drive unit 61 to convey the sheet P on the belt conveyance unit 20 toward the +Y direction which is the forward direction with the belt conveyance unit 20, the upstream conveyance roller pair 21, and the downstream conveyance roller pair 22. Then, immediately before the end portion at the −Y side of the sheet P passes immediately below the upstream sheet sensor 23, that is, immediately before the upstream sheet sensor 23 becomes unable to detect the sheet P, the controller 60 stops the conveyance in the forward direction. In other words, the controller 60 conveys the sheet P in the forward direction in a range in which the upstream sheet sensor 23 can detect the sheet P. As a result, the sheet P comes into the same state as the state illustrated in FIG. 23, that is, the state where the vicinity of the end portion at the −Y side is nipped by the upstream conveyance roller pair 21.

After the state in which the vicinity of the end portion at the −Y side of the sheet P is nipped by the upstream conveyance roller pair 21 is achieved via step S330 or step S350, the controller 60 controls the posture switching drive unit 41 to start the rotation of the belt conveyance unit 20 in the +S direction in step S360 in order to change the posture of the belt conveyance unit 20 from the first posture to the second posture.

Further, in step S370, the controller 60 controls the belt drive unit 28 to circulate the conveyance belt 25 of the belt conveyance unit 20 in the −C direction to convey the sheet P in the reverse direction.

Further, in step S380, the controller 60 controls the downstream roller drive unit 63 to convey the sheet P in the reverse direction with the downstream conveyance roller pair 22. While the belt conveyance unit 20 and the downstream conveyance roller pair 22 convey the sheet P in the reverse direction, the rotation of the upstream conveyance roller pair 21 remains stopped.

Here, although the strict start order of steps S360, S370, and S380 does not matter, it is preferable for these steps to be performed substantially simultaneously in parallel. That is, it is preferable that the downstream conveyance roller pair 22 and the belt conveyance unit 20 convey the sheet P in the reverse direction while the belt conveyance unit 20 rotates in the +S direction.

As shown in FIG. 25, when the sheet P is conveyed in the reverse direction with the belt conveyance unit 20 and the downstream conveyance roller pair 22 while rotating the belt conveyance unit 20 in the +S direction, the sheet P starts to gradually form the curve convex downward in the vertical direction. Then, as shown in FIG. 26, when the posture of the belt conveyance unit 20 becomes the second posture, and further, when the end portion at the +Y side of the sheet P passes the downstream conveyance roller pair 22 to reach an area above the belt conveyance unit 20, the sheet P forms a greatly curved shape.

In step S390, the controller 60 controls the posture switching drive unit 41 and the conveyance drive unit 61 to stop the rotation of the belt conveyance unit 20 and the conveyance by the downstream conveyance roller pair 22 and the belt conveyance unit 20. Specifically, when the posture of the belt conveyance unit 20 becomes the second posture, the controller 60 controls the posture switching drive unit 41 to stop the rotation of the belt conveyance unit 20. Further, when the end portion at the +Y side of the sheet P passes through the downstream conveyance roller pair 22 to reach an area above the belt conveyance unit 20, the controller 60 controls the conveyance drive unit 61 to stop the conveyance by the downstream conveyance roller pair 22 and the belt conveyance unit 20. On this occasion, since the end portion at the downstream side of the sheet P in the conveyance direction is supported by the upstream conveyance roller pair 21, and the end portion at the downstream side of the sheet P in the conveyance direction is supported by the belt conveyance unit 20 in the second posture, the sheet P forms the curve convex downward in the vertical direction. As described above, in the present embodiment, the controller 60 controls the belt conveyance unit 20, the upstream conveyance roller pair 21, and the downstream conveyance roller pair 22 such that the sheet P forms the curve in the state where the upstream sheet sensor 23 has detected the sheet P when the conveyance of the sheet P stops due to the conveyance abnormality or the like.

In step S400, the controller 60 displays, on the operation panel 6, a message announcing that the conveyance abnormality has occurred and a completion of the preparation for removing the sheet P remaining in the straight path 13, and then ends the process.

Further, in step S340, when the position where the conveyance abnormality has occurred is in the straight path 13 and the process has proceeded to step S410, the controller 60 controls the posture switching drive unit 41 to start the rotation of the belt conveyance unit 20 in the +S direction in order to change the posture of the belt conveyance unit 20 from the first posture to the second posture similarly to step S360.

Further, in step S420, similarly to step S370, the controller 60 controls the belt drive unit 28 to circulate the conveyance belt 25 of the belt conveyance unit 20 in the −C direction to convey the sheet P in the reverse direction. It should be noted that when the position where the conveyance abnormality has occurred is in the straight path 13 in step S340, and the process has proceeded to step S410, the end portion at the downstream side in the conveyance direction of the sheet P is not supported by the downstream conveyance roller pair 22 but has already been supported by the belt conveyance unit 20. Therefore, the controller 60 is not required to execute the conveyance in the reverse direction with the belt conveyance unit 20 in step S420.

Then, in step S430, unlike step S380, the controller 60 controls the upstream roller drive unit 62 to convey the sheet P in the forward direction with the upstream conveyance roller pair 21. Subsequently, the controller 60 makes the transition of the process to step S390.

Here, although the strict start order of steps S410, S420, and S430 does not matter, it is preferable for these steps to be performed substantially simultaneously in parallel. That is, as shown in FIG. 27, it is preferable that the rotation of the belt conveyance unit 20 in the +S direction, the conveyance of the sheet P in the reverse direction by the belt conveyance unit 20, and the conveyance of the sheet P in the forward direction by the upstream conveyance roller pair 21 are performed in parallel. In this case, in step S390, when the posture of the belt conveyance unit 20 becomes the second posture, the controller 60 controls the posture switching drive unit 41 to stop the rotation of the belt conveyance unit 20. Further, immediately before the end portion at the −Y side of the sheet P passes immediately below the upstream sheet sensor 23, that is, immediately before the upstream sheet sensor 23 becomes unable to detect the sheet P, the controller 60 controls the conveyance drive unit 61 to stop the conveyance in the forward direction by the upstream conveyance roller pair 21. Further, the controller 60 stops the conveyance of the sheet P in the reverse direction by the belt conveyance unit 20 at a position where the belt conveyance unit 20 can support the downstream side of the sheet P. Thus, the sheet P forms the curve convex downward in the vertical direction.

As described hereinabove, according to the printer 1 of the present embodiment, the following advantages can be obtained.

In the printer 1 according to the present embodiment, the belt conveyance unit 20 is switched from the first posture to the second posture by rotating around the drive shaft 27a located downstream of the center in the conveyance direction of the belt conveyance unit 20 as the rotational axis. In other words, the conveyance surface of the belt conveyance unit 20 is inclined when the upstream side in the conveyance direction moves downward in the vertical direction. Then, the sheet P is supported by the upstream conveyance roller pair 21 and the belt conveyance unit 20 in the second posture, to thereby form the curve.

According to this configuration, it is possible to easily form the curve convex downward by supporting the sheet P with the belt conveyance unit 20 thus inclined and the upstream conveyance roller pair 21 when the rotational axis of the belt conveyance unit 20 is located at the downstream side. Further, according to this configuration, even in a situation where a conveyance abnormality occurs in the sheet P on the belt conveyance unit 20, and the sheet P cannot pass the downstream conveyance roller pair 22, it is possible to form the curve in the sheet P.

Further, the printer 1 according to the present embodiment is further provided with the upstream sheet sensor 23 that detects the sheet P upstream in the conveyance direction of the upstream conveyance roller pair 21, and when the conveyance stops, the controller 60 controls the belt conveyance unit 20, the upstream conveyance roller pair 21, and the downstream conveyance roller pair 22 such that the sheet P forms the curve in the state where the upstream sheet sensor 23 has detected the sheet P.

According to this configuration, by forming the curve in the state where the upstream sheet sensor 23 has detected the sheet P, it is possible to achieve the state where the sheet P is supported by the upstream conveyance roller pair 21 and the belt conveyance unit 20. Further, by keeping the state where the upstream sheet sensor 23 has detected the sheet P, it is possible to detect the removal of the sheet P.

Further, in the printer 1 according to the present embodiment, when the upstream sheet sensor 23 has not detected the sheet P when the conveyance stops, the controller 60 makes the belt conveyance unit 20, the upstream conveyance roller pair 21, and the downstream conveyance roller pair 22 convey the sheet P in the direction opposite to the conveyance direction until the upstream sheet sensor 23 successfully detects the sheet P.

According this configuration, when the upstream sheet sensor 23 does not detect the sheet P, the sheet P is conveyed in a direction opposite to the conveyance direction until the upstream sheet sensor 23 successfully detects the sheet P. Thus, the sheet P can be supported by the upstream conveyance roller pair 21.

Further, in the printer 1 according to the present embodiment, when the upstream sheet sensor 23 has detected the sheet P when the conveyance stops, the controller 60 makes the belt conveyance unit 20, the upstream conveyance roller pair 21, and the downstream conveyance roller pair 22 convey the sheet P in the conveyance direction within a range in which the upstream sheet sensor 23 can detect the sheet P.

According to this configuration, since the upstream conveyance roller pair 21 supports the upstream end portion of the sheet P as a result, even the sheet P short in length can form the curve.

Further, in the method for controlling the printer 1 according to the present embodiment, when the upstream sheet sensor 23 has not detected the sheet P when the conveyance stops in the state where at least a part of the sheet P is supported by the belt conveyance unit 20, the sheet P is conveyed in the direction opposite to the conveyance direction until the upstream sheet sensor 23 successfully detects the sheet P. On the other hand, when the upstream sheet sensor 23 has detected the sheet P when the conveyance stops in the state where at least a part of the sheet P is supported by the belt conveyance unit 20, the sheet P is conveyed in the conveyance direction within the range in which the upstream sheet sensor 23 can detect the sheet P. Then, the belt conveyance unit 20 is rotated around the rotational axis located downstream in the conveyance direction of the center in the conveyance direction of the belt conveyance unit 20 to thereby be separated from the line head 10, and then the belt conveyance unit 20 and the downstream conveyance roller pair 22 are controlled such that the sheet P is supported by the upstream conveyance roller pair 21 and the belt conveyance unit 20 to thereby form the curve convex downward in the vertical direction.

According to this control method, since the sheet P forms the curve convex downward, it becomes possible to retain the ink ejected onto the sheet P in the curved portion. In other words, it is possible to prevent the ink ejected onto the sheet P from flowing down from the sheet P to stain the inside of the printer 1.

The embodiments described above can be modified as follows.

In the embodiments described above, even when the conveyance of the sheet P stops due to the conveyance abnormality or the like, the curve is not required to be formed in the sheet P when the possibility that the ejected ink flows down is low, such as when an amount of the ink ejected onto the sheet P on the belt conveyance unit 20 is small. That is, it is possible for the controller 60 to be able to select first mode in which the sheet P is controlled to form the curve and a second mode in which the sheet P is not controlled to form the curve, based on the amount of the ejected ink or the like. The amount of the ejected ink can be estimated based on, for example, print data. Further, the amount of the ink can be estimated based on the time from when starting the ejection of the ink onto the sheet P on the belt conveyance unit 20 to when stopping the ejection of the ink. Further, when the conveyance stops due to the conveyance abnormality of the sheet P located upstream in the conveyance direction of the sheet P on the belt conveyance unit 20, the sheet P on the belt conveyance unit 20 can be conveyed downstream without switching the posture of the belt conveyance unit 20, and discharged from the discharge unit 7 or the like. By adopting such a configuration, it is possible to prevent the curve from being unnecessarily formed, and thus it becomes possible to promptly remove the sheet P.

Although the belt conveyance unit 20 capable of conveying the sheet P with the conveyance belt 25 is used as a support unit that supports the sheet P at a position opposed to the line head 10 in the embodiment described above, the support unit can be a member that does not have the function of conveying the sheet P.

The drive shaft 26a of the upstream pulley 26 is employed as the rotational axis when rotating the belt conveyance unit 20 in the first embodiment described above, but it is possible to employ a shaft other than the drive shaft 26a as the rotational axis. It should be noted that it is desirable for the rotational axis in the first embodiment to be located upstream in the conveyance direction of the center in the conveyance direction of the belt conveyance unit 20.

Similarly, the drive shaft 27a of the downstream pulley 27 is employed as the rotational axis when rotating the belt conveyance unit 20 in the second embodiment described above, but it is possible to employ a shaft other than the drive shaft 27a as the rotational axis. It should be noted that it is desirable for the rotational axis in the second embodiment to be located downstream in the conveyance direction of the center in the conveyance direction of the belt conveyance unit 20.

In the first embodiment described above, the printer 1 is not required to be provided with the upstream sheet sensor 23. Further, in the second embodiment described above, the printer 1 is not required to be provided with the downstream sheet sensor 24.

In the first embodiment described above, the controller 60 executes step S120 and step S140 in the state where the conveyance of the sheet P stops in step S110, but the conveyance can be continued until the subsequent step S130 or step S150 is executed without stopping the conveyance in step S110. Here, since the operation in step S150 is the conveyance of the sheet P in the forward direction which is the original conveyance direction, it is sufficient for the controller 60 to continue the conveyance in the forward direction when the process has proceeded to step S150. Similarly, in the second embodiment described above, the controller 60 executes step S320 and step S340 in the state where the conveyance of the sheet P stops in step S310, but the conveyance can be continued until the subsequent step S330, S350, or step S420 is executed without stopping the conveyance in step S310. Here, since the operation in step S350 is the conveyance of the sheet P in the forward direction which is the original conveyance direction, it is sufficient for the controller 60 to continue the conveyance in the forward direction when the process has proceeded to step S350.

In the embodiments described above, the upstream sheet sensor 23 and the downstream sheet sensor 24 can each be configured to detect the sheet P by a sensor other than the optical sensor such as a contact-type sensor. Further, when the upstream sheet sensor 23 and the downstream sheet sensor 24 are each formed of the optical sensor, the sensors can be transmissive sensors or reflective sensors.

In the embodiments described above, the belt conveyance unit 20 electrostatically adsorbs the sheet P to the conveyance belt 25, but this configuration is not a limitation. For example, a configuration in which the sheet P is adsorbed due to suction of the air can be adopted.

In the embodiments described above, the controller 60 detects the conveyance abnormality such as the sheet jam based on the detection result of the plural sheet sensors such as the upstream sheet sensor 23 and the downstream sheet sensor 24, but this configuration is not a limitation. For example, the controller 60 can detect the conveyance abnormality based on an increase in load in the conveyance drive unit 61, and so on.

In the embodiments described above, the controller 60 notifies the user of the occurrence of the conveyance abnormality and the completion of the preparation for removing the sheet P by displaying the message on the operation panel 6, but this configuration is not a limitation. For example, notification can be performed by lighting or blinking of a light emitting diode, or it is possible to adopt a configuration of performing the notification with a sound.

In the embodiments described above, the liquid ejected by the line head 10 is not limited to the ink. For example, the line head 10 can eject a liquid material including materials such as an electrode material or a coloring material to be used for manufacturing various types of display in a dispersed or dissolved state. In other words, the liquid ejection apparatus is not limited to the printer 1, and can be a manufacturing apparatus that manufactures various types of displays and the like.

In the embodiments described above, the sheet P is used as a medium, but the material of the medium is not particularly limited, and various materials capable of forming the curve such as textile such as cloth or woven cloth, or vinyl chloride resin, in other words, various materials having flexibility can be adopted.

What is claimed is:

1. A liquid ejection apparatus comprising:
a recording unit configured to perform recording by ejecting liquid onto a medium;
a conveyance unit configured to convey the medium, and;
a controller configured to control the conveyance unit, wherein
the conveyance unit includes
a support unit opposed to the recording unit, and configured to support the medium on which the liquid is ejected,
an upstream conveyance unit located upstream in a conveyance direction of the support unit of the medium, and configured to convey the medium to the support unit, and
a downstream conveyance unit located downstream in the conveyance direction of the support unit, and configured to convey the medium from the support unit,
the support unit is displaced between a first position opposed to the recording unit and a second position at a longer distance from the recording unit than the first position by rotating taking an axis along a width direction crossing the conveyance direction as a rotational axis, and
when the conveyance stops in a state where at least a part of the medium is supported by the support unit, the controller controls the support unit to be displaced to the second position and controls the conveyance unit such that the medium forms a curve convex downward in a vertical direction.

2. The liquid ejection apparatus according to claim 1, wherein
the rotational axis is located upstream in the conveyance direction of a center in the conveyance direction of the support unit,
the second position is a position where the support unit is inclined when a downstream in the conveyance direction of the support unit moves downward in the vertical direction, and
the medium is supported by the downstream conveyance unit and the support unit located at the second position to thereby form the curve.

3. The liquid ejection apparatus according to claim 2, further comprising:
a detection unit configured to detect the medium at a position downstream in the conveyance direction of the downstream conveyance unit, wherein
when the conveyance stops, the controller controls the conveyance unit such that the medium forms the curve in a state where the detection unit detects the medium.

4. The liquid ejection apparatus according to claim 3, wherein
when the detection unit fails to detect the medium when the conveyance stops, the controller makes the conveyance unit convey the medium in the conveyance direction until the detection unit detects the medium.

5. The liquid ejection apparatus according to claim 3, wherein
when the detection unit detects the medium when the conveyance stops, the controller makes the conveyance unit convey the medium in a direction opposite to the conveyance direction within a range for the detection unit to detect the medium.

6. The liquid ejection apparatus according to claim 1, wherein
the rotational axis is located downstream in the conveyance direction of a center in the conveyance direction of the support unit,
the second position is a position where the support unit is inclined when an upstream side in the conveyance direction of the support unit moves downward in the vertical direction, and
the medium is supported by the upstream conveyance unit and the support unit located at the second position to thereby form the curve.

7. The liquid ejection apparatus according to claim 6, further comprising:
a detection unit configured to detect the medium at a position upstream in the conveyance direction of the upstream conveyance unit, wherein
when the conveyance stops, the controller controls the conveyance unit such that the medium forms the curve in a state where the detection unit detects the medium.

8. The liquid ejection apparatus according to claim 7, wherein
when the detection unit fails to detect the medium when the conveyance stops, the controller makes the conveyance unit convey the medium in a direction opposite to the conveyance direction until the detection unit detects the medium.

9. The liquid ejection apparatus according to claim 7, wherein
when the detection unit detects the medium when the conveyance stops, the controller makes the conveyance unit convey the medium in the conveyance direction within a range for the detection unit to detect the medium.

10. The liquid ejection apparatus according to claim 1, wherein
the support unit includes a conveyance belt configured to adsorb and convey the medium, and
the controller controls the conveyance belt when forming the curve.

11. The liquid ejection apparatus according to claim 1, wherein
the controller selects one of
a first mode in which the conveyance unit is controlled such that the medium forms the curve when the conveyance stops in a state in which at least a part of the medium is supported by the support unit, and
a second mode in which the conveyance unit is not controlled such that the medium forms the curve when the conveyance stops in the state in which at least a part of the medium is supported by the support unit.

12. The liquid ejection apparatus according to claim 1, wherein
the controller announces an occurrence of an abnormality after the medium forms the curve.

13. The liquid ejection apparatus according to claim 1, wherein
the support unit is displaceable to a third position farther from the recording unit than the second position.

14. A method of controlling a liquid ejection apparatus including a recording unit configured to perform recording by ejecting liquid onto a medium, a support unit opposed to the recording unit, and configured to support the medium on which the liquid is ejected, an upstream conveyance unit located upstream in a conveyance direction of the support unit of the medium, and configured to convey the medium to the support unit, a downstream conveyance unit located downstream in the conveyance direction of the support unit, and configured to convey the medium from the support unit, and a detection unit configured to detect the medium at a position downstream in the conveyance direction of the downstream conveyance unit, the method comprising:
conveying the medium in the conveyance direction until the detection unit detects the medium when the detection unit fails to detect the medium when the conveyance stops in a state where at least a part of the medium is supported by the support unit;
conveying the medium in an opposite direction to the conveyance direction within a range for the detection unit to detect the medium when the detection unit detects the medium when the conveyance stops in the state where at least a part of the medium is supported by the support unit;
separating the support unit from the recording unit by rotating the support unit centering on a rotational axis located upstream in the conveyance direction of a center in the conveyance direction of the support unit; and
controlling the upstream conveyance unit and the support unit such that the medium is supported by the downstream conveyance unit and the support unit to thereby form a curve convex downward in a vertical direction.

15. A method of controlling a liquid ejection apparatus including a recording unit configured to perform recording by ejecting liquid onto a medium, a support unit opposed to the recording unit, and configured to support the medium on which the liquid is ejected, an upstream conveyance unit located upstream in a conveyance direction of the support unit of the medium, and configured to convey the medium to the support unit, a downstream conveyance unit located downstream in the conveyance direction of the support unit, and configured to convey the medium from the support unit, and a detection unit configured to detect the medium at a position upstream in the conveyance direction of the upstream conveyance unit, the method comprising:
conveying the medium in an opposite direction to the conveyance direction until the detection unit detects the medium when the detection unit fails to detect the medium when the conveyance stops in a state where at least a part of the medium is supported by the support unit;
conveying the medium in the conveyance direction within a range for the detection unit to detect the medium when the detection unit detects the medium when the conveyance stops in the state where at least a part of the medium is supported by the support unit;
separating the support unit from the recording unit by rotating the support unit centering on a rotational axis located downstream in the conveyance direction of a center in the conveyance direction of the support unit; and
controlling the support unit and the downstream conveyance unit such that the medium is supported by the upstream conveyance unit and the support unit to thereby form a curve convex downward in a vertical direction.
